(19) United States
(12) Patent Application Publication
(10) Pub. No.: US 2023/0356198 A1
(43) Pub. Date: Nov. 9, 2023

(54) Catalyst Composition Comprising Ferrite-Based Magnetic Material Adapted for Inductive Heating

(71) Applicant: BASF CORPORATION, FLORHAM PARK, NJ (US)

(72) Inventors: Matthew T. Caudle, Hamilton, NJ (US); Stanley A. Roth, Yardley, PA (US)

(73) Assignee: BASF CORPORATION, FLORHAM PARK, NJ (US)

(21) Appl. No.: 18/030,144

(22) PCT Filed: Oct. 5, 2021
(86) PCT No.: PCT/US2021/053453

§ 371 Date: Apr. 4, 2023

Related U.S. Application Data
(60) Provisional application No. 63/089,247, filed on Oct. 8, 2020.

(51) Int. Cl. B01J 23/83; B01J 29/76; B01J 23/42; B01J 23/44; B01J 23/46; B01J 23/80; B01J 23/755; B01J 21/04; B01J 23/10; B01J 35/00; B01J 35/10; B01J 35/04; B01J 37/08; B01J 8/02; F01N 3/10; F01N 3/20; F01N 3/035; F01N 3/28; B01D 53/94

(52) U.S. Cl. CPC B01J 23/83; B01J 29/763; B01J 23/42; B01J 23/44; B01J 23/464; B01J 23/80; B01J 23/755; B01J 21/04; B01J 23/10; B01J 35/0033; B01J 35/1014; B01J 35/0013; B01J 35/04; B01J 37/08; B01J 8/0285; F01N 3/101; F01N 3/106; F01N 3/2066; F01N 3/035; F01N 3/2828; F01N 3/2026; B01D 53/9418; B01D 53/9431; B01D 53/9436; B01D 53/9454; B01D 53/945; B01D 53/9495; B01D 53/944; B01D 53/9422; B01J 2208/00433; F01N 2370/04; F01N 2330/06; B01D 2255/20738; B01D 2255/20753; B01D 2255/20792; B01D 2255/20746; B01D 2255/2061; B01D 2255/9207; B01D 2257/404; B01D 2257/406; B01D 2257/502; B01D 2258/01

(57) ABSTRACT

The disclosure provides a catalyst composition that includes a catalytic material and a magnetic ferrite compound. The magnetic ferrite compound can be pretreated, for example, by heating prior to incorporation within the catalyst composition. The magnetic ferrite compound may include iron, and one or more additional metals including zinc, cobalt, nickel, yttrium, manganese, copper, barium, strontium, scandium, and lanthanum. The disclosure also includes a system and method for heating the catalyst composition, which employs a conductor for receiving current and generating an alternating magnetic field in response thereto.

This application claims the benefit of priority of U.S. Provisional Application No. 63/089,247, filed Oct. 8, 2020, the contents of which are incorporated by reference herein in their entirety.

The present disclosure relates to catalyst compositions that can be used, e.g., to coat catalyst substrates, providing articles for use in treating engine effluent, methods for the preparation and use of such catalyst substrates and articles, and systems employing such catalyst compositions and articles.

Emissions from diesel engines include nitrogen oxides (NOₓ), unburned hydrocarbons (HC), carbon monoxide (CO), and particulate matter (PM). NOₓ is a term used to describe various chemical species of nitrogen oxides, including nitrogen monoxide (NO) and nitrogen dioxide (NO₂), among others. The HC content of exhaust can vary depending on engine type and operating parameters, but may include a variety of short-chain hydrocarbons such as methane, ethane, propane, and the like, as well as longer-chain fuel-based hydrocarbons. Two exemplary components of exhaust particulate matter are the soluble organic fraction (SOF) and the soot fraction. The SOF condenses on the soot in layers, and is may be derived from unburned diesel fuel and lubricating oils. The SOF can exist in diesel exhaust either as a vapor or as an aerosol (i.e., fine droplets of liquid condensate), depending on the temperature of the exhaust gas. Soot may be predominately composed of particles of carbon.

Catalysts used to treat the exhaust of internal combustion engines may be less effective during periods of relatively low temperature operation, such as the initial cold-start period of engine operation, because the engine exhaust may not be at a temperature sufficiently high for efficient catalytic conversion to occur. This may be particularly true for the downstream catalyst components, especially those placed after a high-thermal mass filter, such as an SCR catalyst, which can take several minutes to reach a suitable operating temperature.

Use of on-board, electric power to heat a catalyst article during start-up conditions has been suggested. Various methods include, e.g., preheating gas via resistive heating of a heating element (see, e.g., U.S. Pat. No. 8,479,496 to Gonze et al.; U.S. Pat. No. 10,690,031 to Barrientos Betancourt et al.; U.S. Pat. No. 6,112,519 to Shimasaki et al.; and U.S. Pat. No. 8,156,737 to Gonze et al.); direct resistive heating of a catalyst substrate (see, e.g., U.S. Pat. Appl. Publ. No. US2011/0072805 and U.S. Pat. No. 10,677,127 to Achenbach et al.); and resistive heating of conductive elements in a ceramic substrate (see, e.g., U.S. Pat. No. 10,731,534 to Stigimair et al.; U.S. Pat. No. 10,681,779 to Noro; U.S. Pat. No. 9,845,714 to Mori et. al.; U.S. Pat. No. 8,784,741 to Yoshioka et al.; and U.S. Pat. No. 8,329,110 to Kinoshita et al.). In an approach, the heat is generated by the electric heater, e.g., electric wires wrapped outside the catalyst substrate, a heated grid, or a metallic substrate itself serving as the heating element. Several challenges to successful commercialization of such systems exist, including the relatively high energy consumption required and the relatively low heating efficiency due to the need to first heat the catalyst substrate. In addition, some electric heating designs may use metallic substrates and may not be compatible with the more widely-adopted ceramic substrates used as a catalyst carrier in many systems. Various engine management strategies have also been suggested to address decreased efficiency during the initial cold-start period (see, e.g., U.S. Pat. No. 10,138,781 to Host et al.; U.S. Pat. No. 10,082,047 to Joshi et al.; U.S. Pat. No. 9,506,426 to Remes; U.S. Pat. No. 10,273,906 to McQuillen et al.; U.S. Pat. No. 6,657,315 to Peters et al.; U.S. Pat. No. 8,955,473 to Zhang; and U.S. Pat. No. 9,382,857 to Glugla et al.).

Induction heating of catalyst bodies has been explored recently (see, e.g., U.S. Pat. Nos. 9,488,085; 10,132,221; and U.S. Pat. No. 10,352,214 to Crawford and Douglas). Current technology employs metallic electrically conductive elements embedded in a ceramic substrate, which are heated by induction of eddy currents in the conductor. Non-contact induction heating of catalysts may have several advantages. There may be no need for a direct electrical connection to the catalyst body.

They may incorporate a ceramic support for the catalyst washcoat. But the current technology suffers from complexity in manufacture (e.g., melding ceramic/metallic interfaces) and inhomogeneity in the distribution of heat. In addition, the heating of the catalyst article is done indirectly, by first heating the embedded metallic elements and diffusing the heat out to the rest of the catalyst.

There is a continuing need in the art to reduce tailpipe emissions of gaseous pollutants from gasoline or diesel engines. Further, there is a need to reduce breakthrough emissions that occur during cold start of the engine or during other low-temperature operation points.

The disclosure provides catalyst compositions comprising a magnetic component (e.g., a ferrite-containing component) that can be inductively heated. Such catalyst compositions can be used, e.g., for the production of monolithic flow-through substrates for treatment of engine exhaust gas (e.g., in the context of diesel and gasoline-powered vehicles), as well as for fixed bed reactor designs (e.g., in the context of chemical catalysis). The disclosed components and methods can allow for the heating of a catalyst material when exposed to an alternating magnetic field, allowing for non-contact heating wherein heat is generated directly in the vicinity of the catalyst material via a magnetic component (e.g., ferrite-containing component) as disclosed herein.

In some embodiments, a catalyst composition comprises, a catalytic material, and a magnetic ferrite compound. In some embodiments, the magnetic ferrite compound is prepared by heating the ferrite compound at a temperature of about 400° C. to about 1200° C. for about an hour or more.

In some embodiments, a catalyst composition comprises a catalytic material; and a magnetic ferrite compound, wherein the magnetic ferrite compound is prepared by heating a ferrite compound such that the Brunauer-Emmett-Teller (BET) surface area of the ferrite compound is increased decreased to a value of less than about 100 m²/g.

In some embodiments, the magnetic ferrite compound is prepared by heating a mixed ferrite compound at a temperature of about 600° C. to about 900° C. for about an hour or more. In some embodiments, the magnetic ferrite compound is prepared by heating a mixed ferrite compound at a temperature of about 750° C. or greater. In some embodiments, the fresh mixed ferrite compound is in the form of nanoparticles. In some embodiments, the temperature of the catalyst composition is increased when it is exposed to an alternating magnetic field.

In some embodiments, the magnetic ferrite compound comprises iron, and one or more of zinc, cobalt, nickel, yttrium, manganese, copper, barium, strontium, scandium, and lanthanum. For example, the magnetic ferrite compound may comprise iron, zinc, and one or more of cobalt, and nickel. In some embodiments the magnetic ferrite compound comprises yttrium.

In some embodiments, the magnetic ferrite compound comprises iron, cobalt, and zinc. In some embodiments, the ratio of various metal components within such mixed ferrite magnetic compounds can vary widely. For example, in some embodiments, the cobalt/zinc molar ratio is about 50/50. In some embodiments, the cobalt/zinc molar ratio is from about 1/99 to about 99/1. In some embodiments, the cobalt/zinc molar ratio is from about 25/75 to about 75/25. In one particular embodiment, the magnetic ferrite compound comprises Co_{0.5}Zn_{0.5}Fe₂O₄.

In some embodiments, the magnetic ferrite compound comprises iron, nickel, and zinc. Again, the ratio of the components of such mixed magnetic ferrite compounds can vary widely. For example, in some embodiments, the nickel/zinc molar ratio is about 50/50. In some embodiments, the nickel/zinc molar is from about 1/99 to about 99/1. In some embodiments, the nickel/zinc molar ratio is from about 25/75 to about 75/25. In one particular embodiment, the magnetic ferrite compound comprises Ni_{0.5}Zn_{0.5}Fe₂O₄.

In some embodiments, the catalytic material comprises a catalytic material for one or more of oxidation of carbon monoxide, oxidation of hydrocarbons, oxidation of NOx, oxidation of ammonia, selective catalytic reduction of NOx. and NOx storage/reduction. In some embodiments, the catalytic material comprises one or more catalytic metals impregnated or ion-exchanged in a porous support. In some embodiments, the porous support may be, for example, a refractory metal oxide or a molecular sieve. In some embodiments, the one or more catalytic metals may be, for example, selected from base metals, platinum group metals, oxides of base metals or platinum group metals, and combinations thereof.

In some embodiments, a catalytic article for treatment of exhaust gas emissions from an internal combustion engine, comprises: a substrate in the form of a flow-through substrate or wall-flow filter, having a catalyst composition as provided herein deposited thereon. In some embodiments, the catalytic article is adapted for use as a diesel oxidation catalyst (DOC), catalyzed soot filter (CSF), lean NOx trap (LNT), selective catalytic reduction (SCR) catalyst, ammonia oxidation (AMOx) catalyst, or three-way catalyst (TWC).

In some embodiments, an emission control system comprises: a catalytic article as provided herein; and a conductor for receiving alternating current (AC) and generating an alternating magnetic field in response thereto, the conductor positioned such that the generated alternating magnetic field is applied to at least a portion of the catalyst composition. In some embodiments, the conductor is in the form of conductive wire surrounding at least part of the catalytic article. In some embodiments, an emission control system is provided which further comprises an electric power source electrically connected to the conductor for supplying alternating current thereto. In some embodiments, the emission control system further comprises a temperature sensor positioned to measure the temperature of gases entering the catalytic article and a controller in communication with the temperature sensor, the controller adapted for control of the current received by the conductor such that the controller can energize the conductor with current when inductive heating of the catalytic article is desired. In some embodiments, a method of treating exhaust gas emissions from an internal combustion engine, comprises: passing the exhaust gas emissions through an emission control system as provided herein.

In some embodiments, a catalyst for fixed bed reactor design, comprises a catalyst bed having a catalyst composition as provided herein contained therein. In some embodiments, a fixed bed catalyst system, comprises such a catalyst and a conductor for receiving current and generating an alternating magnetic field in response thereto, the conductor positioned such that the generated alternating magnetic field is applied to at least a portion of the catalyst composition.

In some embodiments, the present disclosure is directed to methods for producing a catalytic material. In some embodiments, a method for producing a catalytic material, comprises: heating a mixed ferrite compound at a temperature of about 600° C. or greater for about an hour or more to give a mixed magnetic ferrite compound; and combining the mixed magnetic ferrite compound with a catalytic material. In some embodiments, the mixed magnetic ferrite compound is in the form of particles. In some embodiments, the mixed magnetic ferrite compound is in the form of nanoparticles. In some embodiments, a method for producing a catalytic material, comprises: heating a mixed ferrite compound for a time and at a temperature sufficient to decrease the Brunauer-Emmett-Teller (BET) surface area of the ferrite compound to an area of less than about 100 m²/g; and combining the heated ferrite compound with a catalytic material. Such method can advantageously, in some embodiments, be a method for producing an inductively heatable catalytic material.

The disclosure includes, without limitation, the following additional embodiments:

Embodiment 1: A catalyst composition comprising: a catalytic material; and at least one magnetic component, wherein the magnetic component comprises at least one magnetic ferrite compound.

Embodiment 2: The catalyst composition of the preceding embodiment, wherein the magnetic ferrite compound comprises iron, and one or more of zinc, cobalt, nickel, yttrium, manganese, copper, barium, strontium, scandium, and lanthanum.

Embodiment 3: The catalyst composition of any preceding embodiment, wherein the magnetic ferrite compound comprises iron, and one or more of zinc, cobalt, nickel, and yttrium.

Embodiment 4: The catalyst composition of any preceding embodiment, wherein the magnetic ferrite compound comprises iron, nickel, and zinc.

Embodiment 5: The catalyst composition of any preceding embodiment, wherein the nickel/zinc molar ratio is from about 1/99 to about 99/1.

Embodiment 6: The catalyst composition of any preceding embodiment, wherein the nickel/zinc molar ratio is from about 25/75 to about 75/25.

Embodiment 7: The catalyst composition of any preceding embodiment, wherein the nickel/zinc molar ratio is about 50/50.

Embodiment 8: The catalyst composition of any preceding embodiment, wherein the magnetic ferrite compound comprises Ni_{0.5}Zn_{0.5}Fe₂O₄.

Embodiment 9: The catalyst composition of any preceding embodiment, wherein the magnetic ferrite compound comprises iron, cobalt, and zinc.

Embodiment 10: The catalyst composition of any preceding embodiment, wherein the cobalt/zinc molar ratio is from about 1/99 to about 99/1.

Embodiment 11: The catalyst composition of any preceding embodiment, wherein the cobalt/zinc molar ratio is from about 25/75 to about 75/25.

Embodiment 12: The catalyst composition of any preceding embodiment, wherein the cobalt/zinc molar ratio is about 50/50.

Embodiment 13: The catalyst composition of any preceding embodiment, wherein the magnetic ferrite compound comprises Co_{0.5}Zn_{0.5}Fe₂O₄.

Embodiment 14: The catalyst composition of any preceding embodiment, wherein the magnetic ferrite compound comprises iron and yttrium.

Embodiment 15: The catalyst composition of any preceding embodiment, wherein the magnetic ferrite compound comprises Y₃Fe₅O₁₂.

Embodiment 16: The catalyst composition of any preceding embodiment, wherein the magnetic ferrite compound is prepared by heating at a temperature of about 400° C. to about 1200° C. for about an hour or more.

Embodiment 17: The catalyst composition of any preceding embodiment, wherein the magnetic ferrite compound is prepared by heating at a temperature of about 600° C. to about 900° C. for about an hour or more.

Embodiment 18: The catalyst composition of any preceding embodiment, wherein the magnetic ferrite compound has a Brunauer-Emmett-Teller (BET) surface area of less than about 100 m²/g.

Embodiment 19: The catalyst composition of any preceding embodiment, wherein the magnetic ferrite compound is the form of nanoparticles.

Embodiment 20: The catalyst composition of any preceding embodiment, wherein the temperature of the catalyst composition is increased by exposure to an alternating magnetic field.

Embodiment 21: The catalyst composition of any preceding embodiment, wherein the catalytic material comprises a catalytic material for one or more of oxidation of carbon monoxide, oxidation of hydrocarbons, oxidation of NOx, oxidation of ammonia, selective catalytic reduction of NOx, and NOx storage/reduction.

Embodiment 22: The catalyst composition of any preceding embodiment, wherein the catalytic material comprises one or more catalytic metals impregnated or ion-exchanged in a porous support.

Embodiment 23: The catalyst composition of any preceding embodiment, wherein the porous support is a refractory metal oxide or a molecular sieve.

Embodiment 24: The catalyst composition of any preceding embodiment, wherein the one or more catalytic metals are selected from base metals, platinum group metals, oxides of base metals or platinum group metals, and combinations thereof.

Embodiment 25: A catalytic article for treatment of exhaust gas emissions from an internal combustion engine, comprising: a substrate in the form of a flow-through substrate or wall-flow filter, having the catalyst composition of any of the preceding embodiments deposited thereon.

Embodiment 26: The catalytic article of the preceding embodiment, adapted for use as a diesel oxidation catalyst (DOC), catalyzed soot filter (CSF), lean NOx trap (LNT), selective catalytic reduction (SCR) catalyst, ammonia oxidation (AMOx) catalyst, or three-way catalyst (TWC).

Embodiment 27: An emission control system comprising: the catalytic article of any preceding embodiment; and a conductor for receiving current and generating an alternating magnetic field in response thereto, the conductor positioned such that the generated alternating magnetic field is applied to at least a portion of the catalyst composition.

Embodiment 28: The emission control system of the preceding embodiment, wherein the conductor is in the form of a coil of conductive wire surrounding at least part of the catalytic article.

Embodiment 29: The emission control system of any preceding embodiment, further comprising an electric power source electrically connected to the conductor for supplying alternating current thereto.

Embodiment 30: The emission control system of any preceding embodiment, further comprising a temperature sensor positioned to measure the temperature of gases entering the catalytic article and a controller in communication with the temperature sensor, the controller adapted for control of the current received by the conductor such that the controller can energize the conductor with current when heating of the catalytic article is desired.

Embodiment 31: A method of treating exhaust gas emissions from an internal combustion engine, comprising passing the exhaust gas emissions through the emission control system of any preceding embodiment.

Embodiment 32: A catalyst for fixed bed reactor design comprising a catalyst bed having the catalyst composition wherein the catalyst composition comprises a catalytic material and at least one magnetic component, wherein the magnetic component comprises at least one magnetic ferrite compound.

Embodiment 33: A fixed bed catalyst system, comprising the catalyst of the preceding embodiment and a conductor for receiving current and generating an alternating magnetic field in response thereto, the conductor positioned such that the generated alternating magnetic field is applied to at least a portion of the catalyst composition.

Embodiment 34: A method for producing a catalytic material, comprising: heating a ferrite compound at a temperature of about 600° C. or greater for about an hour or more to give magnetic ferrite compound; and combining the heated ferrite compound with a catalytic material.

Embodiment 35: A method for producing a catalytic material, comprising: heating a ferrite compound for a time and at a temperature sufficient to decrease the Brunauer-Emmett-Teller (BET) surface area of the ferrite compound to an area of less than about 100 m²/g to give a heated ferrite compound; and combining the heated ferrite compound with a catalytic material.

Embodiment 36: A catalyst composition comprising: a catalytic material; and a plurality of treated mixed ferrite magnetic particles, wherein the treated mixed ferrite magnetic particles are prepared by heating fresh mixed ferrite magnetic particles at a temperature of about 750° C. or greater for about an hour or more.

Embodiment 37: The catalyst composition of the preceding embodiment, wherein the treated mixed ferrite magnetic particles are prepared by heating fresh mixed ferrite magnetic particles at a temperature of about 900° C. or greater for about an hour or more.

Embodiment 38: A catalyst composition comprising: a catalytic material; and a plurality of treated mixed ferrite magnetic particles, wherein the treated mixed ferrite magnetic particles are prepared by heating fresh mixed ferrite magnetic particles such that the Brunauer-Emmett-Teller (BET) surface area of the fresh mixed ferrite magnetic particles is increased by a factor of 10 or more to a value of less than about 20 m²/g.

Embodiment 39: The catalyst composition of any preceding embodiment, wherein the fresh mixed ferrite magnetic particles are in the form of nanopowders.

Embodiment 40: The catalyst composition of any preceding embodiment, wherein the catalyst composition is inductively heatable.

Embodiment 41: The catalyst composition of any preceding embodiment, wherein the treated mixed ferrite magnetic particles comprise iron, and one or more of zinc, cobalt, nickel, yttrium, manganese, copper, barium, strontium, scandium, and lanthanum.

Embodiment 42: The catalyst composition of any preceding embodiment, wherein the treated mixed ferrite magnetic particles comprise iron, zinc, and one or more of cobalt, nickel, and yttrium.

Embodiment 43: The catalyst composition of any preceding embodiment, wherein the treated mixed ferrite magnetic particles comprise iron, cobalt, and zinc.

Embodiment 44: The catalyst composition of any preceding embodiment, wherein the cobalt and zinc are in a weight ratio of about 1:1.

Embodiment 45: The catalyst composition of any preceding embodiment, wherein the cobalt and zinc are in a weight ratio of less than 1:1.

Embodiment 46: The catalyst composition of any preceding embodiment, wherein the cobalt and zinc are in a weight ratio of greater than 1:1.

Embodiment 47: The catalyst composition of any preceding embodiment, wherein the treated mixed ferrite magnetic particles comprise iron, nickel, and zinc.

Embodiment 48: The catalyst composition of any preceding embodiment, wherein the nickel and zinc are in a weight ratio of about 1:1.

Embodiment 49: The catalyst composition of any preceding embodiment, wherein the nickel and zinc are in a weight ratio of less than 1:1.

Embodiment 50: The catalyst composition of any preceding embodiment, wherein the nickel and zinc are in a weight ratio of greater than 1:1.

Embodiment 51: The catalyst composition of any preceding embodiment, wherein the treated mixed ferrite magnetic particles comprise Ni_{0.5}Zn_{0.5}Fe₂O₄.

Embodiment 52: The catalyst composition of any preceding embodiment, wherein the treated mixed ferrite magnetic particles comprise Co_{0.5}Zn_{0.5}Fe₂O₄.

Embodiment 53: The catalyst composition of any preceding embodiment, wherein the catalytic material comprises a catalytic material for one or more of oxidation of carbon monoxide, oxidation of hydrocarbons, oxidation of NOx, oxidation of ammonia, selective catalytic reduction of NOx, and NOx storage/reduction.

Embodiment 54: The catalyst composition of any preceding embodiment, wherein the catalytic material comprises one or more catalytic metals impregnated or ion-exchanged in a porous support.

Embodiment 55: The catalyst composition of any preceding embodiment, wherein the porous support is a refractory metal oxide or a molecular sieve.

Embodiment 56: The catalyst composition of any preceding embodiment, wherein the one or more catalytic metals are selected from base metals, platinum group metals, oxides of base metals or platinum group metals, and combinations thereof.

Embodiment 57: A catalytic article for treatment of exhaust gas emissions from an internal combustion engine, comprising: a substrate in the form of a flow-through substrate or wall-flow filter, having the catalyst composition of any of the preceding embodiments deposited thereon.

Embodiment 58: The catalytic article of the preceding embodiment, adapted for use as a diesel oxidation catalyst (DOC), catalyzed soot filter (CSF), lean NOx trap (LNT), selective catalytic reduction (SCR) catalyst, ammonia oxidation (AMOx) catalyst, or three-way catalyst (TWC).

Embodiment 59: An emission control system comprising: the catalytic article of any preceding embodiment; and a conductor for receiving current and generating an alternating magnetic field in response thereto, the conductor positioned such that the generated alternating electromagnetic field is applied to at least a portion of the catalyst composition.

Embodiment 60: The emission control system of the preceding embodiment, wherein the conductor is in the form of conductive wire surrounding at least part of the catalytic article.

Embodiment 61: The emission control system of any preceding embodiment, further comprising an electric power source electrically connected to the conductor for supplying alternating current thereto.

Embodiment 62: The emission control system of any preceding embodiment, further comprising a temperature sensor positioned to measure the temperature of gases entering the catalytic article and a controller in communication with the temperature sensor, the controller adapted for control of the current received by the conductor such that the controller can energize the conductor with current when inductive heating of the catalytic material is desired.

Embodiment 63: A catalyst for fixed bed reactor design, comprising a catalyst bed having the catalyst composition of any preceding embodiment contained therein.

Embodiment 64: A fixed bed catalyst system, comprising: the catalyst of the preceding embodiment; and a conductor for receiving current and generating an alternating magnetic field in response thereto, the conductor positioned such that the generated alternating electromagnetic field is applied to at least a portion of the catalyst composition.

Embodiment 65: A method of treating exhaust gas emissions from an internal combustion engine, comprising passing the exhaust gas emissions through the emission control system of any preceding embodiment.

Embodiment 66: A method for producing a catalytic material, comprising: heating fresh mixed ferrite magnetic particles at a temperature of about 750° C. or greater for about an hour or more to give pre-calcined mixed ferrite magnetic particles, and combining a plurality of the pre-calcined mixed ferrite magnetic particles with a catalytic material.

Embodiment 67: A method for producing a catalytic material, comprising: heating fresh mixed ferrite magnetic particles for a time and at a temperature sufficient to increase the Brunauer-Emmett-Teller (BET) surface area of the fresh mixed ferrite magnetic particles by a factor of 10 or more to give pre-calcined mixed ferrite magnetic particles; and combining a plurality of the pre-calcined mixed ferrite magnetic particles with a catalytic material.

Embodiment 68: The method of any preceding embodiment, wherein the method is a method for producing an inductively heatable catalytic material.

These and other features, aspects, and advantages of the disclosure will be apparent from a reading of the following detailed description together with the accompanying drawings, which are briefly described below. The disclosure includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosure, in any of its various aspects and embodiments, may be viewed as intended to be combinable unless the context clearly dictates otherwise. Other aspects and advantages of the present disclosure will become apparent from the following.

### BRIEF DESCRIPTION OF THE DRAWINGS

In order to provide an understanding of embodiments of the disclosure, reference is made to the appended drawings, which are not necessarily drawn to scale, and in which reference numerals refer to components of exemplary embodiments of the disclosure. The drawings are exemplary only, and should not be construed as limiting the disclosure.

FIG. 1A is a perspective view of a honeycomb-type catalyst 2 with inlet end 6 and outlet end 8, and channels 10, which may comprise a substrate carrier having a catalyst composition disposed thereon, wherein the catalyst composition is in accordance with the present disclosure, comprising a magnetic ferrite compound;

FIG. 1B is a partial cross-sectional view of 2 enlarged relative to FIG. 1A and taken along a plane parallel to the end faces of 2 of FIG. 1A, which shows an enlarged view of a plurality of the gas flow passages 10 shown in FIG. 1A, with walls 12 and washcoat layers 14 and 16;

FIG. 2 is a cutaway view of a section enlarged relative to FIG. 1A, wherein the honeycomb-type substrate carrier in FIG. 1A represents a wall flow filter substrate monolith;

FIG. 3 is a schematic depiction of an embodiment of an emission treatment system 32 in which a catalyst of the present disclosure is utilized:

FIG. 4 is a schematic depiction of one configuration wherein a catalyst 2 of the present disclosure is utilized, and which illustrates an electrical conductor 66, controller 74, power source 70, and temperature sensor 72;

FIG. 5 is a schematic depiction of an embodiment of an emission treatment system 51 in which more than one catalyst of the present disclosure is utilized, and which illustrates associated electrical conductors, controllers, power sources, and temperature sensors;

FIG. 6 is a photograph of an experimental setup showing the arrangement of the packed sample, induction coil and cooling air jets, and the position of the analysis and control thermocouple probes:

FIG. 7 is a graph showing temperature change (circles) and heating rate (bars) of various ferrite compounds of Example 1 after calcination at 750° C. for 5 hours in air, and during exposure to an alternating magnetic field;

FIG. 8 is a graph showing the thermal power loss to the powder bed for Co_{0.5}Zn_{0.5}Fe₂O₄, Ni_{0.5}Zn_{0.5}Fe₂O₄, and Y₃Fe₅O₁₂, prior to calcination and after calcination at 600° C., 750° C., and 900° C. during exposure to an alternating magnetic field,

FIG. 9 is an X-ray diffraction pattern for Ni_{0.5}Zn_{0.5}Fe₂O₄ powder prior to calcination and after calcination at 750° C. for 5 hours in static air;

FIG. 10 is X-ray diffraction pattern for NiFe₂O₄ powder prior to calcination and after calcination at 750° C. for 5 hours in static air;

FIG. 11 is a graph showing powder bed temperature as a function of time during exposure to an alternating magnetic field for Ni_{0.5}Zn_{0.5}Fe₂O₄, Co_{0.5}Zn_{0.5}Fe₂O₄, Y₃Fe₅O₂, and Fe₃O₄,

FIG. 12 is a plot of thermal power loss (W) as a function the mass fraction of Ni_{0.5}Zn_{0.5}Fe₂O₄ (balance=Al₂O₃) in a 1.8 g sample of powder (where the solid line is the theoretical thermal loss assuming no dissipation of heat to the environment),

FIG. 13A is a graph showing NOₓ conversion as a function of temperature, under feed conditions relevant to operation of an SCR catalyst, for model powders containing a copper-exchanged zeolite and either Ni_{0.5}Zn_{0.5}Fe₂O₄ (SCR-IHC) or Al₂O₃(SCR-only), and an inset showing T₅₀ for NOₓ conversion,

FIG. 13B is a graph showing powder bed temperature as a function of time, during exposure to an alternating magnetic field, for model powders containing a copper-exchanged zeolite and either Ni_{0.5}Zn_{0.5}Fe₂O₄ (SCR-IHC) or Al₂O₃ (SCR-only),

FIG. 14A is a graph showing NH₃ conversion as a function of temperature, under feed conditions relevant to operation of an AMOx catalyst, for model powders containing a Pt/Al₂O₃+copper-exchanged zeolite and either Ni_{0.5}Zn_{0.5}Fe₂O₄(AMOx-IHC) or Al₂O₃ (AMOx-only), and an inset showing T₅₀ for NH₃ conversion,

FIG. 14B is a graph showing powder bed temperature as a function of time, during exposure to an alternating magnetic field, for model powders containing a Pt/Al₂O₃+copper-exchanged zeolite and either Ni_{0.5}Zn_{0.5}Fe₂O₄ (AMOx-IHC) or Al₂O₃(AMOx-only),

FIG. 15A is a graph showing average CO conversion as a function of temperature, under oscillating feed conditions relevant to operation of a TWC catalyst, for model powders containing a Rh/Al₂O₃+Pd on CeZr oxide and either Ni_{0.5}Zn_{0.5}Fe₂O₄(TWC-IHC) or Al₂O₃ (TWC-only), and an inset showing T₅₀ for CO conversion,

FIG. 15B is a graph showing average NOx conversion as a function of temperature, under oscillating feed conditions relevant to operation of a TWC catalyst, for model powders containing a Rh/Al₂O₃+Pd on CeZr oxide and either Ni_{0.5}Zn_{0.5}Fe₂O₄ (TWC-IHC) or Al₂O₃ (TWC-only),

FIG. 16 is a graph showing powder bed temperature as a function of time, during exposure to an alternating magnetic field, for model powders containing a Rh/Al₂O+Pd on CeZr oxide and either Ni_{0.5}Zn_{0.5}Fe₂O₄ (TWC-IHC) or Al₂O₃ (TWC-only),

FIG. 17A is a graph showing CO conversion as a function of temperature, under feed conditions relevant to operation of a DOC catalyst, for model powders containing a Pt+Pd on Al₂O₃ and either Ni_{0.5}Zn_{0.5}Fe₂O₄ (DOC-IHC) or Al₂O₃(DOC-only), and an inset showing Tso for CO conversion,

FIG. 17B is a graph showing powder bed temperature as a function of time, during exposure to an alternating magnetic field, for model powders containing a Pt+Pd on Al₂O₃ and either Ni_{0.5}Zn_{0.5}Fe₂O₄ (DOC-IHC) or Al₂O₃ (DOC-only),

FIG. 18A is a graph showing stored NOₓ as a function of temperature, under oscillating feed conditions relevant to operation of an LNT catalyst, for model powders containing Rh/CeO₂+Pt/Pd on aluminum oxide+barium+Mg+Zr and either Ni_{0.5}Zn_{0.5}Fe₂O₄ (LNT-IHC) or Al₂O₃ (LNT-only),

FIG. 18B is a graph showing powder bed temperature as a function of time, during exposure to an alternating magnetic field, for model powders containing Rh/CeO₂+Pt/Pd on aluminum oxide+barium+Mg+Zr and either Ni_{0.5}Zn_{0.5}Fe₂O₄ (LNT-IHC) or Al₂O₃ (LNT-only),

FIG. 19A is a graph showing NOₓ conversion as a function of temperature, under feed conditions relevant to operation of an SCR catalyst, for ceramic monoliths coated with a model catalyst formulation containing a copper-exchanged zeolite (SCR-only), or a copper-exchanged zeolite and Ni_{0.5}Zn_{0.5}Fe₂O₄ (SCR-IHC), and an inset showing NH₃ conversion as a function of temperature,

FIG. 19B is a graph showing bed temperature as a function of time, during exposure to an alternating magnetic field, for ceramic monoliths coated with a model catalyst formulation containing a copper-exchanged zeolite (SCR-only), or a copper-exchanged zeolite and Ni_{0.5}Zn_{0.5}Fe₂O₄ (SCR-IHC),

FIG. 20A shows infrared images of the SCR-IHC monolith before application of the alternating magnetic field (left) and during application of the alternating magnetic field (right), and

FIG. 20B shows infrared images of metal foil monolith before application of the alternating magnetic field (left) and during application of the alternating magnetic field (right).

FIG. 21 shows an exemplary apparatus used to evaluate coated monoliths for catalytic activity and magnetic induction heating.

FIG. 22A shows the lightoff profile for an exemplary SCR-only monolith with the current to the external coil turned off or turned on.

FIG. 22B shows the lightoff profile for an exemplary SCR-IHC monolith with the current to the external coil turned off or turned on.

FIG. 23 shows the increase in catalyst internal temperature (T_{power on}−T_{power off}) at varying baseline temperature points.

The present disclosure additional provided hereinafter. Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure may include modifications and variations that are within the scope of the appended claims and their equivalents. It is to be understood that the disclosure is not limited to the details of construction or process steps set forth in the following description. The disclosure is capable of other embodiments and of being practiced or being carried out in various ways. Like numbers refer to like elements throughout. As used in this specification and the claims, the singular forms “a,” “an,” and “the” include plural referents unless the context clearly dictates otherwise.

The term “about” used throughout is used to describe and account for small fluctuations. For instance, “about” may mean the numeric value may be modified by ±5%, ±4%, ±3%, ±2%, ±1%, ±0.5%, ±0.4%, ±0.3%, ±0.2%, ±0.1% or 0.05%. All numeric values are modified by the term “about” whether or not explicitly indicated. Numeric values modified by the term “about” include the specific identified value. For example, “about 5.0” includes 5.0.

As used herein, the term “base metal” refers to an alkali metal, an alkaline earth metal, a lanthanide, a post-transition metal, a transition metal (except Rh, Pd, Ag, Ir, Pt and Au), B, Si, Ge, Sb, and combinations thereof.

In some embodiments, the magnetic ferrite compounds exhibit certain beneficial characteristics. In some embodiments, catalytic articles comprises a substrate and one or more catalyst compositions in the form of washcoat layers thereon, wherein at least one of the one or more catalyst compositions comprises the disclosed magnetic ferrite compound. In some embodiments, the inclusion of a magnetic ferrite compound within a catalyst composition provides a material therein that is inductively heatable via application of an alternating magnetic field, and is particularly advantageous at times in which a catalyst system needs to reach an operating temperature conducive to catalytic activity in a short period of time, such as during cold-start of an engine. In some embodiments, by enabling a catalyst material to reach a desired temperature more quickly, undesirable gaseous pollutant breakthrough normally associated with operation of the catalyst at low temperature can be minimized. In some embodiments, the substrate onto which the magnetic ferrite-containing catalyst composition is disposed typically provides a plurality of wall surfaces upon which the catalyst composition is applied and adhered, thereby acting as a carrier for the catalyst composition. In some embodiments, the substrate can be of the type typically used for preparing automotive catalysts and will typically comprise a metal or ceramic honeycomb structure.

### Catalyst Composition

In some embodiments, the catalyst composition provided herein comprises one or more magnetic ferrite compounds, which will be described in further detail herein below. In some embodiments, the catalyst composition can further comprise, e.g., any catalytically active materials commonly employed in emission control systems of, e.g., gasoline or diesel engines and/or any catalytically active materials commonly employed in chemical catalysis within fixed bed reactors.

In some embodiments, various catalyst compositions into which the disclosed magnetic ferrite compounds can be incorporated are known and can be employed in the context of the present disclosure.

In some embodiments, ferrite compounds are generally understood to be ceramic materials comprising iron(III) oxide in combination with one or more additional metallic elements. In some embodiments, ferrites can be described as defect spinel structures with a counter-ion of 2+ or 3+ charge. In some embodiments, ferrite compounds have magnetic properties and some such ferrites are known for use in, e.g., electronic and electrical devices.

In some embodiments, the magnetic ferrite compounds can generally comprise iron in combination with one or more other metals and, in certain embodiments, in combination with two or more other metals. Such other metals, in some embodiments, comprise transition metals. In some embodiments, such other metals comprise main group metals. In some embodiments, the one or more other metals can vary and can be, e.g., chosen from zinc, cobalt, nickel, yttrium, manganese, copper, barium, strontium, scandium, and lanthanum. In some embodiments, the magnetic ferrite compound comprises iron and zinc. In some embodiments, the magnetic ferrite compound comprises iron, zinc, and a further metal, such as those referenced herein above. In some embodiments, a magnetic ferrite compound comprises iron, zinc, and one or more of cobalt and nickel, e.g., magnetic ferrite compounds comprising iron, zinc, and cobalt; or iron, zinc, and nickel. In some embodiments the magnetic ferrite compound comprises iron and yttrium.

In some embodiments, the molar ratio of the metal components of the magnetic ferrite compounds provided herein can vary. In some embodiments, the molar content of iron within the magnetic ferrite compound is higher than the molar content of any other individual metal provided within the magnetic ferrite compound. In some embodiments, the molar content of iron within the magnetic ferrite compound is higher than the combined molar content of all other metals within the magnetic ferrite compound.

In some embodiments, where two other metals (in addition to the iron) are incorporated within the magnetic ferrite compound, the two other metals can be provided in varying molar ratios with respect to one another. In some embodiments, the molar ratio of the two metals is from about 1/99 to about 99/1. In some embodiments, the two metals are in a molar ratio from about 25/75 to about 75/25. In some embodiments, the two other metals are in roughly a 50/50 ratio. In some embodiments, magnetic ferrite compounds include, but are not limited, to nickel-zinc-iron oxides (e.g., including Ni_{0.5}Zn_{0.5}Fe₂O₄) and cobalt-zinc-iron oxides (e.g., including Co_{0.5}Zn_{0.5}Fe₂O₄).

In some embodiments, the magnetic ferrite compound comprises particles of varying particle sizes. In some embodiments, the magnetic ferrite compound comprises a powder comprising particles of average diameter greater than about 100 nm. In some embodiments, the magnetic ferrite compound can be described as comprising a nanopowder. In some embodiments, a nanopowder comprises nanoparticles, with average particle diameter of about 100 nm or below (e.g., about 1 nm to about 100 nm in diameter). In some embodiments, a nanopowder includes, e.g., agglomerates of ultrafine particles, nanoparticles, or nanoclusters. For example, in some embodiments, the magnetic ferrite compound in the catalyst compositions described herein comprises particles with average particle size ranging from about 20 nm to about 100 nm, such as about 20 nm, about 30 nm, about 40 nm, about 50 nm, about 60 nm, about 70 nm, about 80 nm, about 90 nm, or about 100 nm. In some embodiments, the particles are of substantially similar particle size, i.e., the particles in the compositions provided herein are substantially monodisperse; however, the particles are not limited to being monodisperse or substantially monodisperse and a given sample of particles may comprise particles of varying dispersity in various embodiments. The shape of the particles is generally spherical in some embodiments; however, the particles are not limited to being spherical or substantially spherical and may comprise elongated structures, sheet-like structures, and other shapes in various embodiments.

In some embodiments, the magnetic ferrite compound is chosen so as to exhibit high stability and retention of magnetic characteristics after exposure to high temperatures (e.g., temperatures to which catalyst compositions may be exposed within an exhaust gas treatment system during operation of an engine). In some embodiments, the magnetic ferrite compound is chosen so as to exhibit high stability and retention of magnetic characteristics after exposure to temperatures used for accelerated aging of catalyst compositions. For example, catalyst compositions in a heavy-duty diesel (HDD) exhaust gas treatment system are commonly exposed to a temperature of about 650° C. or more and catalyst compositions in a light-duty diesel (LDD) exhaust gas treatment system are commonly exposed to a temperature of about 750° C. or more.

It was found that not all magnetic ferrite compounds exhibit magnetic properties after exposure to such elevated temperatures (and thus cannot be suitably used for inductive heating of an adjacent material, e.g., a catalyst composition into which they are incorporated). It was found that even certain magnetic ferrite compounds that exhibited suitable magnetic properties after exposure to only low temperatures (e.g., T<600° C.) did not necessarily exhibit magnetic properties after being exposed to elevated temperatures (e.g., T≥600° C.). In some embodiments, it was surprisingly found that certain magnetic ferrite compound that did not exhibit substantial magnetic properties after exposure to only low temperatures did exhibit magnetic properties upon exposure to elevated temperature. In some embodiments, magnetic ferrite compounds exhibit suitable magnetic properties upon exposure to an alternating magnetic field (e.g., sufficient heat loss to heat a catalyst composition when incorporated therein) after exposure to elevated temperatures (e.g., temperatures of about 600° C. or more or about 750° C. or more).

In some embodiments, stability and magnetic characteristics render a magnetic ferrite compounds suitable for inductive heating of catalysts and are within a catalyst composition and provide heating of the catalyst composition when exposed to an alternating magnetic field. In some embodiments, magnetic ferrite compounds provide inductive heating of an adjacent material (e.g., a catalyst composition into which they are incorporated) are provided by calcination. In some embodiments, calcination comprises heating ferrite compounds. The temperature to which the ferrite compound is heated can vary, e.g., in some embodiments, the particles are heated to a temperature of about 600° C. or greater, a temperature of about 750° C. or greater, a temperature of about 800° C. or greater, a temperature of about 850° C. or greater, or a temperature of about 900° C. or greater. The time for which such particles are kept at an elevated temperature is not particularly limited; in some embodiments, the particles can be held at the elevated temperature for about 5 minutes or more, about 10 minutes or more, about 20 minutes or more, about 30 minutes or more, about 45 minutes or more, or about 1 hour or more.

Without being limited by theory, calcination may cause an increase in the crystallite size and/or primary particle size of the ferrite compound. Crystallites or particles that are larger in size may contain multiple magnetic domains within which individual magnetic moments may align but across which they may not be aligned. Upon exposure to an external magnetic field the magnetic moments may align with the external field, and may cause a migration of the boundaries between magnetic domains. Resistance to the migration of these domain boundaries may lead to magnetic hysteresis and induction heating of the magnetic material. Generation of larger magnetic particles by calcination or other means may lead to more domain boundaries, and to a material more effective for induction heating, which may, at least partially, explain the enhanced inductive heating capability of certain magnetic ferrite compounds following the calcination heating described in some embodiments herein. In some embodiments, suitable calcination is evaluated by measuring a decrease in BET surface area of the ferrite compound before and after calcination.

“BET surface area” has its usual meaning of referring to the Brunauer, Emmett, Teller methods for determining surface area by N₂ absorption. Unless otherwise specifically stated, all references herein to the surface area of the magnetic ferrite compound (or other catalytic composition components) means the BET surface area.

In some embodiments, suitable calcination to provide the inductive magnetic heating properties described herein is provided when the BET surface area of the ferrite compound is decreased below about 100 m²/g. In some embodiments. BET surface area reductions that can be monitored and determined to provide the desired inductive heating properties can vary, e.g., based on the primary particle size and/or crystallite size of the initial material (i.e., if the primary particle size and/or crystallite size of the initial material is larger, a smaller decrease in BET surface area may be sufficient).

Although the calcination method outlined herein may, in some embodiments, be employed to provide a magnetic ferrite compound that provides suitable inductive heating properties, it is noted that this method for providing such particles is not intended to be limiting. Other methods are encompassed herein for providing a suitable magnetic ferrite compound. In some embodiments, the magnetic ferrite compound may be provided which exhibit desired features (e.g., reasonably large primary particle sizes, reasonably large crystallites, etc.) and such particles may be directly used without requiring calcination treatment to obtain the desired inductive heating properties.

The magnetic ferrite compounds described herein are incorporated within a catalytic composition, e.g., as known in the art. The amount of magnetic ferrite compound (e.g., calcined magnetic ferrite compound) incorporated within a given catalyst composition is at least that amount sufficient to heat at least a portion of the catalyst composition when it is exposed to an alternating magnetic field. Exemplary amounts of mixed ferrite particles that can be incorporated within a given catalyst composition to provide such heating capabilities can, in certain embodiments, range from about 5% to about 90% by weight.

The types of catalyst compositions into which the magnetic ferrite compound can be incorporated are not particularly limited. In some embodiments, any catalyst composition that may be advantageously heated may benefit from the inclusion of the disclosed magnetic ferrite compounds. As provided above, such catalyst compositions can, in some embodiments, be compositions suitable for treatment of exhaust gases, e.g., in the form of a washcoat on a catalyst article within an engine exhaust gas treatment system (as described in greater detail herein below). In some embodiments, catalyst compositions can be adapted for one or more of oxidation of carbon monoxide, oxidation of hydrocarbons, oxidation of nitrogen oxides (NOₓ), oxidation of ammonia, and selective catalytic reduction of NOₓ, and NOₓ storage/reduction.

In some embodiments, catalyst compositions include one or more catalytic metals impregnated or ion-exchanged in a porous support, with exemplary supports including refractory metal oxides and molecular sieves. In some embodiments, the catalytic metal is chosen from base metals, platinum group metals, oxides of base metals or platinum group metals, and combinations thereof. In some embodiments, the catalytic material used in the disclosure can be described based on function and type, as well as materials of construction as noted above. For example, the catalyst material can be a diesel oxidation catalyst (DOC), a catalyzed soot filter (CSF), a lean NOx trap (LNT), a selective catalytic reduction (SCR) catalyst, an SCR catalyst on a filter (SCRoF), an ammonia oxidation (AMOx) catalyst, or a three-way catalyst (TWC). Additional examples include catalytically active particles adapted for use as a volatile organic hydrocarbon (VOC) oxidation catalyst or a room temperature hydrocarbon oxidation catalyst.

In some embodiments, a DOC or CSF catalyst comprises one or more PGM components impregnated on a metal oxide support such as alumina, optionally further including an oxygen storage component (OSC) such as ceria or ceria/zirconia, and provides oxidation of both hydrocarbons and carbon monoxide.

In some embodiments, an LNT catalyst contains one or more PGM components impregnated on a support and NOx trapping components (e.g., ceria and/or alkaline earth metal oxides). In some embodiments, an LNT catalyst is capable of adsorbing NOx under lean conditions and reducing the stored NOx to nitrogen under rich conditions.

In some embodiments, an SCR catalyst is adapted for catalytic reduction of nitrogen oxides with a reductant in the presence of an appropriate amount of oxygen. Reductants may be, for example, hydrocarbon, hydrogen, and/or ammonia. In some embodiments, SCR catalysts comprise a molecular sieve (e.g., a zeolite) ion-exchanged with a promoter metal such as copper or iron, with exemplary SCR catalysts comprising FeBEA zeolite, FeCHA and CuCHA zeolites. In some embodiments, the exemplary SCR catalysts comprise vanadium supported on a refractory metal oxide, comprising TiO₂, WO₃, CeO₂, or Al₂O₃.

In some embodiments, a TWC catalyst refers to the function of three-way conversion where hydrocarbons, carbon monoxide, and nitrogen oxides are substantially simultaneously converted. In some embodiments, a TWC catalyst comprises one or more platinum group metals such as palladium and/or rhodium and optionally platinum, and an oxygen storage component. In some embodiments, under rich conditions, TWC catalysts typically generate ammonia.

In some embodiments, an AMOx catalyst refers to an ammonia oxidation catalyst, which is a catalyst containing one or more metals suitable to convert ammonia, and which is generally supported on a support material such as alumina or titania. In some embodiments, n exemplary AMOx catalyst comprises a copper zeolite in conjunction with a supported platinum group metal (e.g., platinum impregnated on alumina).

In some embodiments, methods of making such catalyst compositions often involve impregnation of a porous support with a PGM or base metal solution and/or an ion-exchange process of molecular sieves with a metal precursor solution. In some embodiments, methods for making catalyst compositions that can be used to prepare catalyst compositions are generally known in the art, e.g., as described in U.S. Pat. No. 9,138,732 to Bull et al and U.S. Pat. No. 8,715,618 to Trukhan et al., which are incorporated by reference therein in their entireties. In some embodiments, catalyst compositions can be modified according to the present disclosure to include the types of magnetic ferrite compound described herein above. In some embodiments, the catalytically active components of the catalyst composition are mixed substantially homogeneously with the magnetic ferrite compound to provide the inductively heatable catalyst composition.

### Substrate

In some embodiments, a catalyst composition as disclosed herein (e.g., a catalyst composition including, but not limited to, a DOC, LNT. AMOx, SCR, or TWC catalyst composition comprising the magnetic ferrite compound as described herein) is disposed on a substrate to form a catalytic article. In some embodiments, catalytic articles are employed as part of an exhaust gas treatment system (e.g., catalyst articles including, but not limited to, articles including the magnetic ferrite compound disclosed herein). In some embodiments, substrates are 3-dimensional, having a length and a diameter and a volume, similar to a cylinder. In some embodiments, the shape does not necessarily have to conform to a cylinder. In some embodiments, the length is an axial length defined by an inlet end and an outlet end.

In some embodiments, the substrate for the disclosed catalyst composition(s) may be constructed of any material typically used for preparing automotive catalysts and, in some embodiments, comprises a metal or ceramic honeycomb structure. In some embodiments, the substrate provides a plurality of wall surfaces upon which the washcoat composition is applied and adhered, thereby acting as a substrate for the catalyst.

In some embodiments, ceramic substrates are made of any suitable refractory material, e.g. cordierite, cordierite-α-alumina, aluminum titanate, silicon titanate, silicon carbide, silicon nitride, zircon mullite, spodumene, alumina-silica-magnesia, zircon silicate, sillimanite, a magnesium silicate, zircon, petalite, α-alumina, an aluminosilicate and the like.

In some embodiments, substrates may also be metallic, comprising one or more metals or metal alloys. In some embodiments, a metallic substrate may include any metallic substrate, such as those with openings or “punch-outs” in the channel walls. In some embodiments, the metallic substrates may be employed in various shapes such as pellets, compressed metallic fibers, corrugated sheet or monolithic foam. In some embodiments, metallic substrates include heat-resistant, base-metal alloys, especially those in which iron is a substantial or major component. Such alloys may contain one or more of nickel, chromium, and aluminum, and the total of these metals may comprise at least about 15 wt/o (weight percent) of the alloy, for instance, about 10 wt % to about 25 wt % chromium, about 1 wt % to about 8 wt % of aluminum, and from 0 wt % to about 20 wt % of nickel, in each case based on the weight of the substrate. In some embodiments, metallic substrates include those having straight channels; those having protruding blades along the axial channels to disrupt gas flow and to open communication of gas flow between channels; and those having blades and also holes to enhance gas transport between channels allowing for radial gas transport throughout the monolith.

In some embodiments, any suitable substrate for the catalytic articles disclosed herein may be employed, such as a monolithic substrate of the type having fine, parallel gas flow passages extending there through from an inlet or an outlet face of the substrate such that passages are open to fluid flow there through (“flow-through substrate”). In some embodiments, a substrate is of the type have a plurality of fine, substantially parallel gas flow passages extending along the longitudinal axis of the substrate where, typically, each passage is blocked at one end of the substrate body, with alternate passages blocked at opposite end-faces (“wall-flow filter”). In some embodiments, flow-through and wall-flow substrates are, for example, in International Application Publication No. WO2016/070090, which is incorporated herein by reference in its entirety.

In some embodiments, the catalyst substrate comprises a honeycomb substrate in the form of a wall-flow filter or a flow-through substrate. In some embodiments, the substrate is a wall-flow filter. In some embodiments, the substrate is a flow-through substrate.

### Flow-Through Substrates

In some embodiments, the substrate is a flow-through substrate (e.g., monolithic substrate, including a flow-through honeycomb monolithic substrate). Flow-through substrates have fine, parallel gas flow passages extending from an inlet end to an outlet end of the substrate such that passages are open to fluid flow. The passages, which are essentially straight paths from their fluid inlet to their fluid outlet, are defined by walls on or in which a catalytic coating is disposed so that gases flowing through the passages contact the catalytic material. The flow passages of the flow-through substrate are thin-walled channels, which can be of any suitable cross-sectional shape and size such as trapezoidal, rectangular, square, sinusoidal, hexagonal, oval, circular, etc. The flow-through substrate can be ceramic or metallic as described above.

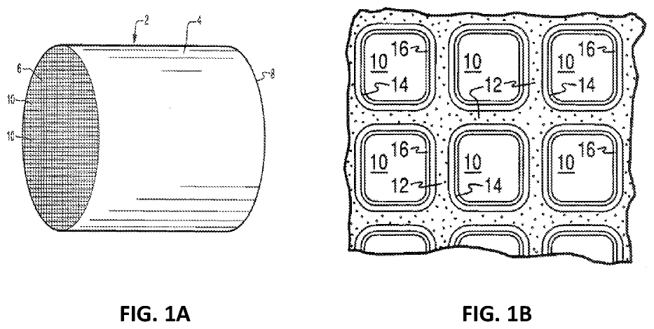

Flow-through substrates can, for example, have a volume ranging from about 50 in³ to about 1200 in³, a cell density (inlet openings) ranging from about 60 cells per square inch (cpsi) to about 500 cpsi or up to about 900 cpsi, for example, ranging from about 200 to about 400 cpsi and a wall thickness ranging from about 50 to about 200 microns or about 400 microns. FIGS. 1A and 1B illustrate an exemplary substrate 2 in the form of a flow-through substrate coated with a catalyst composition as described herein. Referring to FIG. 1A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 1B, flow passages 10 are formed by walls 12 and extend through carrier 2 from upstream end face 6 to downstream end face 8, the passages 10 being unobstructed so as to permit the flow of a fluid, e.g., a gas stream, longitudinally through carrier 2 via gas flow passages 10 thereof. As more easily seen in FIG. 1B, walls 12 are so dimensioned and configured that gas flow passages 10 have a substantially regular polygonal shape. As shown, the catalyst composition can be applied in multiple, distinct layers if desired. In the illustrated embodiment, the catalyst composition consists of both a discrete bottom layer 14 adhered to the walls 12 of the carrier member and a second discrete top layer 16 coated over the bottom layer 14. The present disclosure can be practiced with one or more (e.g., two, three, or four or more) catalyst composition layers and is not limited to the two-layer embodiment illustrated in FIG. 1B.

### Wall-Flow Filter Substrates

In some embodiments, the substrate is a wall-flow filter, and have a plurality of fine, substantially parallel gas flow passages extending along the longitudinal axis of the substrate. In some embodiments, each passage is blocked at one end of the substrate body, with alternate passages blocked at opposite end-faces. In some embodiments, monolithic wall-flow filter substrates may contain up to about 900 or more flow passages (or “cells”) per square inch of cross-section, although far fewer may be used. For example, the substrate may have a range from about 7 to 600, more usually from about 100 to 400, cells per square inch (“cpsi”). In some embodiments, the cells have cross-sections that are rectangular, square, circular, oval, triangular, hexagonal, or are of other polygonal shapes. In some embodiments, the wall-flow filter substrate is ceramic or metallic as described above.

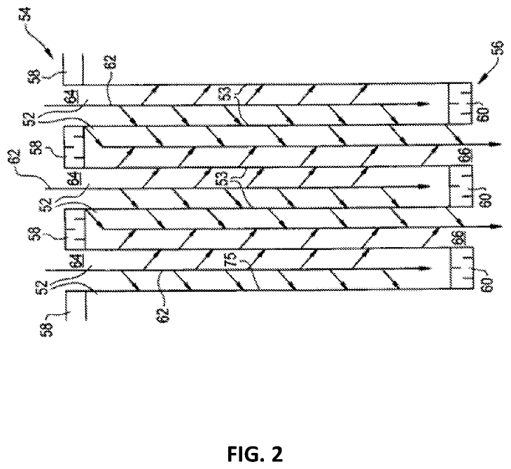

A cross-section view of an exemplary monolithic wall-flow filter substrate section is illustrated in FIG. 2, comprising a plurality of passages (cells) 52 with alternating plugged and open passages. As seen in the figure, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58, and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in certain embodiments is catalyzed in that the wall of said element has thereon or contained therein one or more catalytic materials. Catalytic materials may be present on the inlet side of the element wall alone, the outlet side alone, both the inlet and outlet sides, or the wall itself may be filled with all, or part, of the catalytic material. In some embodiments, one or more layers of catalytic material are within the wall or on the inlet and/or outlet walls of the element.

In some embodiments, the wall-flow filter article substrate has a volume of, for example, from about 50 cm³, about 100 in³, about 200 in³, about 300 in³, about 400 in³, about 500 in³, about 600 in³, about 700 in³, about 800 in³, about 900 in³ or about 1000 in³ to about 1500 in³, about 2000 in³, about 2500 in³, about 3000 in³, about 3500 in³, about 4000 in³, about 4500 in³ or about 5000 in³.

In some embodiments, wall-flow filter substrates have a wall thickness from about 50 microns to about 2000 microns, for example from about 50 microns to about 450 microns or from about 150 microns to about 400 microns.

In some embodiments, the walls of the wall-flow filter are porous and have a wall porosity of at least about 40% or at least about 50% with an average pore diameter of at least about 10 microns prior to disposition of the functional coating. For example, the wall-flow filter article substrate in some embodiments have a porosity of ≥40%, ≥50%, ≥60%, ≥65% or ≥70%. In some embodiments, the wall-flow filter article substrate has a wall porosity of from about 50%, about 60%, about 65% or about 70% to about 75% and an average pore diameter of from about 10 microns, or about 20 microns, to about 30 microns, or about 40 microns prior to disposition of a catalytic coating. The terms “wall porosity” and “substrate porosity” mean the same thing and are interchangeable. Porosity is the ratio of void volume (or pore volume) divided by the total volume of a substrate material. Pore size and pore size distribution may be determined by Hg porosimetry measurement.

### Substrate Coating Process

In some embodiments, the catalyst composition provided herein above is mixed with water (if in dried form) to form a slurry for purposes of coating a catalyst substrate. In some embodiments, in addition to the catalyst particles and the magnetic ferrite compound provided herein above (e.g., in calcined form), the slurry may optionally contain other inorganic binders, associative thickeners, and/or surfactants (including anionic, cationic, non-ionic or amphoteric surfactants). The order of addition can vary; in some embodiments, all components are simply combined together to form the slurry and in some embodiments, certain components are combined and remaining components are then combined therewith. For example, in some embodiments, the catalyst composition can be substantially prepared and the magnetic ferrite compounds are subsequently added thereto. In some embodiments, the magnetic ferrite compounds are added initially so as to be mixed with all other components of the catalyst composition. In some embodiments, the pH of the slurry can be adjusted, e.g., to an acidic pH of about 3 to about 5. When present, an inorganic binder is typically used in an amount ranging from about 0.02 g/in³ to about 0.5 g/in³.

In some embodiments, the slurry is milled to enhance mixing of the particles and formation of a homogenous material. In some embodiments, the milling is accomplished in a ball mill, continuous mill, or other similar equipment, and the solids content of the slurry may be, e.g., from about 20 wt. %, to about 60 wt. %, about 30 wt. %, to about 40 wt. %. In one embodiment, the post-milling slurry is characterized by a D90 particle size of about 10 microns to about 50 microns (e.g., about 10 microns to about 20 microns). The D90 is defined as the particle size at which about 90% of the particles have a finer particle size.

In some embodiments, the slurry is then coated on the catalyst substrate using a washcoat technique known in the art. As used herein, the term “washcoat” has its usual meaning in the art of a thin, adherent coating of a material applied to a substrate, such as a honeycomb flow-through monolith substrate or a filter substrate which is sufficiently porous to permit the passage therethrough of the gas stream being treated. As used herein and as described in Heck, Ronald and Robert Farrauto, Catalytic Air Pollution Control, New York: Wiley-Interscience, 2002, pp. 18-19, a washcoat layer includes a compositionally distinct layer of material disposed on the surface of a monolithic substrate or an underlying washcoat layer. In some embodiments, a substrate contains one or more washcoat layers, and each washcoat layer can have unique chemical catalytic functions. In some embodiments, one or more of the washcoat layers comprise magnetic ferrite compounds as provided herein (and each layer can contain the same or different magnetic ferrite compounds and can contain different amounts of such same or different magnetic ferrite compounds).

In some embodiments, the substrate is dipped one or more times in the slurry or otherwise coated with the slurry. In some embodiments, the coated substrate is dried at an elevated temperature (e.g., from 100° C. to 150° C.) in static air or under a flow or jet of air for about 2 minutes to about 3 hours, and then calcined by heating, e.g., from 400° C. to 600° C., for about 10 minutes to about 3 hours. In some embodiments, following drying and calcining, the final washcoat coating layer is essentially solvent-free.

In some embodiments, after calcining, the catalyst loading can be determined through calculation of the difference in coated and uncoated weights of the substrate. As will be apparent to those of skill in the art, the catalyst loading can be modified by altering the slurry rheology or solids content. In some embodiments, the coating/drying/calcining process is repeated as needed to build the coating to the desired loading level or thickness.

In some embodiments, the catalyst composition is a single layer or in multiple layers. In some embodiments, a catalyst layer resulting from repeated washcoating of the same catalyst material to build up the loading level is a single layer of catalyst. In some embodiments, the catalyst composition is applied in multiple layers with each layer having a different composition. In some embodiments, the catalyst composition can be zone-coated, meaning a single substrate can be coated with different catalyst compositions in different areas along the gas effluent flow path.

### Emission Treatment System

In some embodiments, an emission treatment system incorporates the catalyst article described herein (wherein the catalyst composition comprises the magnetic ferrite compound). In some embodiments, the catalyst article is in an integrated emissions treatment system comprising one or more additional components for the treatment of gasoline or diesel exhaust gas emissions. As such, the terms “exhaust stream”, “engine exhaust stream”. “exhaust gas stream” and the like refer to the engine effluent as well as to the effluent downstream of one or more other catalyst system components as described herein.

In some embodiments, the catalyst article comprising a catalyst composition suitable for inductive heating as disclosed herein is positioned at varying locations within the emission treatment system with respect to other components. In some embodiments, the disclosed catalyst article is coupled directly to the engine. In some embodiments, the distance between the engine and catalyst article can be quite short resulting in a so-called “close coupled” catalytic arrangement. In some embodiments, the distance from the engine to the catalyst can be longer, resulting in an “underfloor” configuration. In some embodiments, the catalyst article disclosed herein can, alternatively, be positioned such that one or more other components are present between the engine and the catalyst article. In some embodiments, for example, one or more other catalyst articles can be present upstream of the disclosed catalyst article. In some embodiments, one or more other catalyst articles can be present downstream of the disclosed catalyst article.

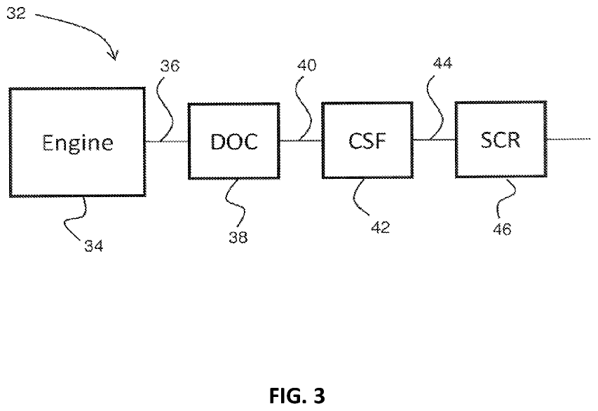

An exemplary emissions treatment system is illustrated in FIG. 3, which depicts a non-limiting, representation of an emission treatment system 32. As shown, an exhaust gas stream containing gaseous pollutants and particulate matter is conveyed via exhaust pipe 36 from an engine 34 to a diesel oxidation catalyst (DOC) 38. In the DOC 38, unburned gaseous and non-volatile hydrocarbons (i.e., the SOF) and carbon monoxide are largely combusted to form carbon dioxide and water. In addition, a proportion of the NO of the NOₓ component may be oxidized to NO₂ in the DOC. The exhaust stream is next conveyed via exhaust pipe 40 to a catalyzed soot filter (CSF) 42, which traps particulate matter present within the exhaust gas stream. The CSF 42 is optionally catalyzed for passive or active soot regeneration. After removal of particulate matter, via CSF 42, the exhaust gas stream is conveyed via exhaust pipe 44 to a downstream selective catalytic reduction (SCR) component 16 for the further treatment and/or conversion of NOₓ. In some embodiments, any or all of the above-noted catalyst components, or other optional catalyst components, could include a catalyst composition as described herein, comprising magnetic ferrite compounds. In some embodiments, the disclosure is not limited thereto; the principles disclosed herein are relevant to a range of different types of catalysts and can be employed in the context of a broad array of catalysts and associated emission treatment systems.

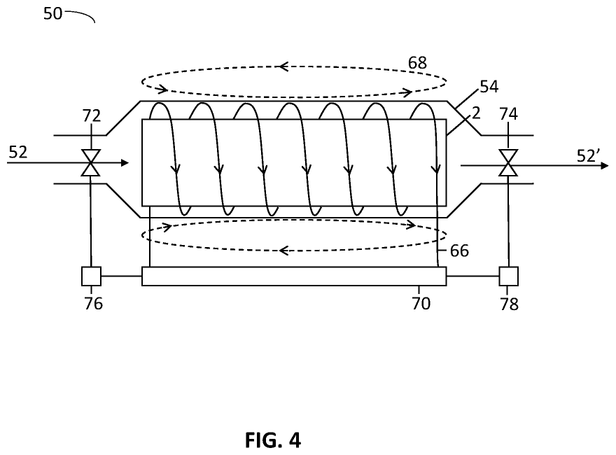

FIG. 4 provides a view of an exemplary catalyst article 50, wherein arrows 52 and 52′ show the direction of travel of an engine effluent (52 indicating the gas entering the catalyst and 52′ indicating the gas exiting/treated by the catalyst). As shown, the exemplary catalyst article 50 includes a catalyst 2 enclosed in an exhaust pipe can 54. In the illustrated embodiment, catalyst 2 comprises a catalyst composition comprising magnetic ferrite compound as described herein. A wire coil 66 surrounds the catalyst 2 in order to provide an alternating magnetic field 68 adapted for induction heating of the magnetic ferrite compound (and thus, due to proximity/contact, also the catalyst composition into which it is incorporated) and this wire coil is attached to power source 70. It is noted that the depicted embodiment is not intended to be limiting of the coil construction. For example, in some embodiments, the coil does not comprise a single coil and, rather, comprises two or more individual coils. In some embodiments, the substrate is surrounded on the front (upstream) end with one coil and on the back (downstream) end with another coil, optionally having a gap there between. In some embodiments, the coil surrounds only a part of the catalyst 2.

It is also noted that the depicted coil 66 wraps around the catalyst axially, such that the magnetic field is parallel to the gas flow. However, the disclosed system is not limited thereto. In some embodiments, the coil 66 (or multiple coils, as referenced above) can be placed laterally on the catalyst, such that the magnetic field generated thereby is transverse to the gas flow.

The wire coil 66 is electrically connected to a power source 70 capable of providing alternating electric current to the coil, with output power typically in the range of about 5 to 50 kW and at a frequency of about 1 to about 1000 kHz (e.g., about 10 kHz to about 500 kHz). In some embodiments, the field strength may determine the extent to which the magnetic ferrite compound within the catalyst composition described herein can be magnetized. The illustrated embodiment is merely one example of the disclosure. In some embodiments, the coil 66 is placed in other locations such as also surrounding the catalyst 54 or other catalyst components of the system. Also, the technology depicted in this figure can be applied to various types of emission catalysts and is not limited to any particular type of catalyst, including, but not limited to, the types of catalysts referenced herein (e.g., SCR, DOC, SCRoF, AMOx, and other catalysts).

The system 50 further includes an optional temperature sensor 72 positioned to measure the temperature of engine effluent gases entering the catalyst 2. Both the power source 70 and the temperature sensors 72 and 74 are operatively connected to controllers 76 and 78, which are configured to control the power source 70 and receive the temperature signals from the sensors. As would be understood, the controllers 76 and 78 can comprises hardware and associated software adapted to allow the controllers to provide instructions to the power source to energize the electric coil 66 at any time when inductive heating of the catalyst 2 is desired. The controllers can select the time period for inductive heating based on a variety of factors, such as, for example, based on a particular temperature set point associated with the temperature sensors 72 and/or 74, at specific time period based on ignition of the engine (e.g. a control system adapted to inductively heat the magnetic ferrite compound for a set time period following engine ignition), or at specific preset time intervals.

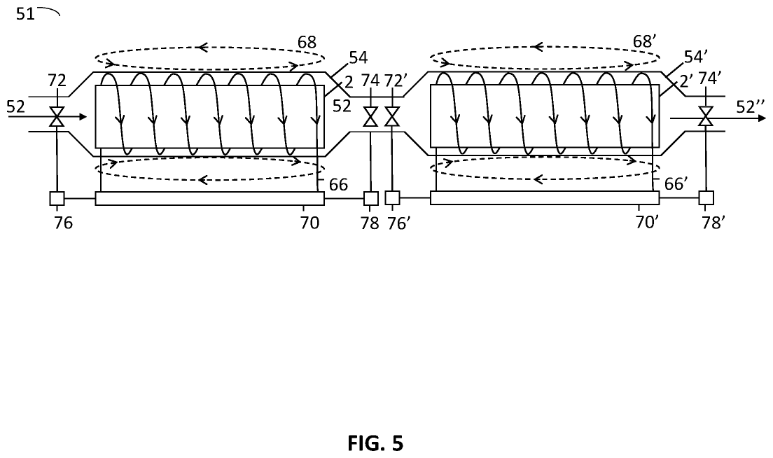

FIG. 5 illustrates system 51, which is a similar system to system 50, but employing more than one inductively heatable catalyst article (each of which contains magnetic ferrite compound, which can be the same or different, and which can comprise the same or different quantities thereof). Electric coils 66 and 66′ surround catalysts 2 and 2′ in order to provide alternating magnetic fields 68 and 68′ adapted for inductive heating of the magnetic ferrite compound within the catalyst compositions. The system includes optional temperature sensors 72, 72′, 74, and 74′, which are operatively connected to controllers 76, 76′, 78 and 78′, respectively, configured to control the associated power sources 70 and 70′ and receive the temperature signals from the corresponding sensors. In some embodiments, there is a single temperature controller in place of 74 and 72′ and, in some embodiments, that temperature sensor may be attached to and configured to control, both power sources 70 and 70′.

In some embodiments, the magnetic ferrite compounds set forth herein are added to the catalyst composition of any catalyst article for which inductive heating of the catalyst coating (or coatings) thereon would be useful to maintain the catalyst composition in an optimal temperature range for catalytic activity. In some embodiments, the desired temperature range varies depending on the catalyst type and function. In some embodiments, the temperature is in the range of about 100° C. to 450° C., about 150° C. to 350° C. In some embodiments, an SCR catalyst is heated to at least about 150° C. to promote useful SCR activity. In some embodiments, a DOC catalyst is heated to at least about 120° C. for useful CO oxidation. In some embodiments, a LNT is heated to at least about 150° C. for useful NOx storage and at least about 250° C. for useful regeneration/NOx reduction.

### EXAMPLES

The present disclosure is further illustrated by the following examples, which are set forth to illustrate the present disclosure and is not to be construed as limiting thereof. Unless otherwise noted, all parts and percentages are by weight, and all weight percentages are expressed on a dry basis, meaning excluding water content, unless otherwise indicated.

### Example 1: Heating of Metal Oxides in the Presence of an Alternating Magnetic Field

Table 1 shows a series of metal oxide materials. Some are ferrites and related defect spinel structures which have well-documented magnetic properties. Aluminum oxide was included in the list as an inert control material that lacks paramagnetic, ferromagnetic, antiferromagnetic, and ferrimagnetic properties.

TABLE 1
Metal oxide materials

| Name | Nominal Composition |
|---|---|
| iron(II, III) oxide | Fe₃O₄ |
| barium ferrite | BaFe₁₂O₁₉ |
| cobalt ferrite | CoFe₂O₄ |
| nickel ferrite | NiFe₂O₄ |
| zinc ferrite | ZnFe₂O₄ |
| cobalt-zinc ferrite | Co_{0.5}Zn_{0.5}Fe₂O₄ |
| nickel-zinc ferrite | Ni_{0.5}Zn_{0.5}Fe₂O₄ |
| manganese-zinc ferrite | Mn_{0.5}Zn_{0.5}Fe₂O₄ |
| strontium ferrite | SrFe₁₂O₁₉ |
| copper ferrite | CuFe₂O₄ |
| yttrium iron oxide | Y₃Fe₅O₁₂ |
| manganese ferrite | MnFe₂O₄ |
| manganese ferrite | MnFe₂O₄ |
| nickel-cobalt ferrite | Ni_{0.5}Co_{0.5}Fe₂O₄ |
| manganese oxide | Mn₃O₄ |
| manganese oxide | Mn₂O₃ |
| manganese oxide | MnO₂ |
| aluminum oxide | Al₂O₃ |

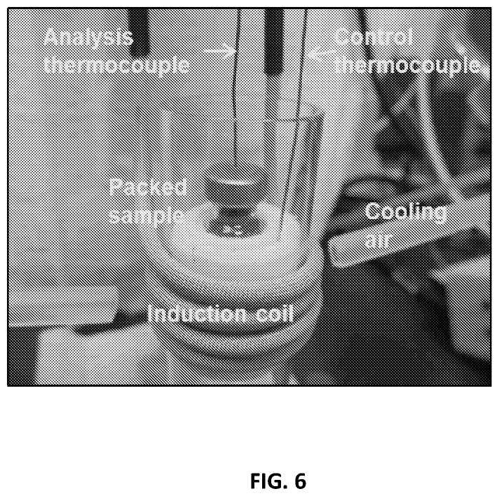

Samples of each powder were calcined at 750° C. in air. The calcined powders were evaluated for magnetic induction heating efficiency using a screening apparatus that comprised a sample powder packed in a sampler vial, wrapped in a flexible ceramic tape, and inserted into a 25 mm inner diameter glass tube. The glass tube was mounted in an induction coil. An AC power supply provided alternating current at 50-60 kHz to the induction coil. One temperature probe wire was inserted into the powder bed, and a second temperature probe wire was inserted into the ceramic tape insulation. FIG. 6 shows a photograph of the apparatus used for measurement of induction heating. The temperature readings from the two probes was recorded while the alternating current was supplied to the coil. Jets of cooling air minimized resistive heating of the induction coil itself. The time taken for the temperature of the powder bed to reach 100° C. was recorded, as well as the temperature reading from the mounting insulation at that time point. If T=100° C. was not reached after 120 sec, then the temperature at 120 sec was recorded. The average heating rate was defined as (T_{final}−Tᵢₙᵢₜᵢₐₗ)/t (° C./s).

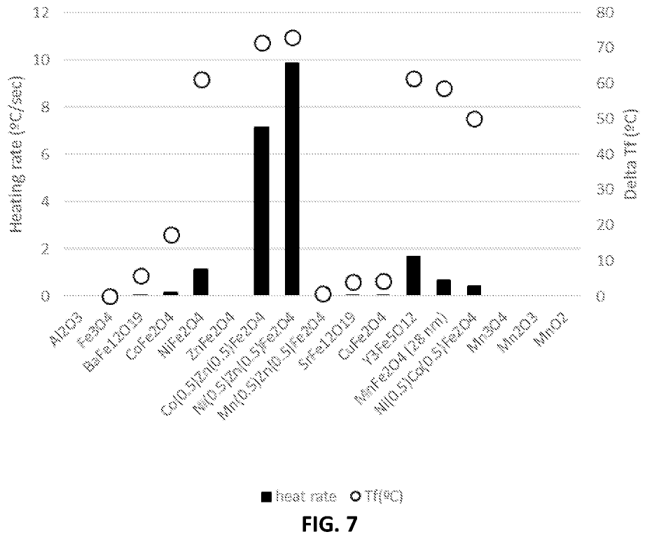

The results of the induction heating trials after calcination at 750° C. are shown in FIG. 7. The open circles show the difference in temperature between the final powder bed temperature and the temperature measured in the insulating wrap, ΔT_{f}. A higher value indicates a material with greater response to the oscillating magnetic field generated inside the induction coil. NiFe₂O₄, Co_{0.5}Zn_{0.5}Fe₂O₄, Ni_{0.5}Zn_{0.5}Fe₂O₄, Y₃Fe₅O₁₂, MnFe₂O₄, and Ni_{0.5}Co_{0.5}Fe₂O₄ show ΔT_{f}>45° C. at the end of the test. For application in induction heating of catalysts, it is also critical that a material be heated rapidly. The black bars in FIG. 7 show the average rate of temperature increase for each material during the test. Among the evaluated samples. Ni_{0.5}Zn_{0.5}Fe₂O₄ and Co_{0.5}Zn_{0.5}Fe₂O₄ showed appreciably higher induction heating response than the other materials after calcination at 750° C. in air. NiFe₂O₄, CoFe₂O₄, and ZnFe₂O₄ showed very low heating rates compared with the Co_{0.5}Zn_{0.5}Fe₂O₄ and Ni_{0.5}Zn_{0.5}Fe₂O₄ compounds. The iron (II,III) oxide Fe₃O₄ showed a high induction heating response in the fresh state, but no thermal response to the alternating magnetic field after calcination at 750° C. which is consistent with the well-known conversion of this oxide to non-magnetic hematite at high temperatures. None of the pure manganese oxides (Mn₃O₄, Mn₂O₃, MnO₂) gave measurable thermal response to the alternating magnetic field. As expected, there was no induction heating response for the diamagnetic oxide Al₂O₃ (which also confirms that there is no inductive heating of the thermocouple wire itself).

### Example 2: Evolution of Magnetic Induction Behavior with Calcination Temperature

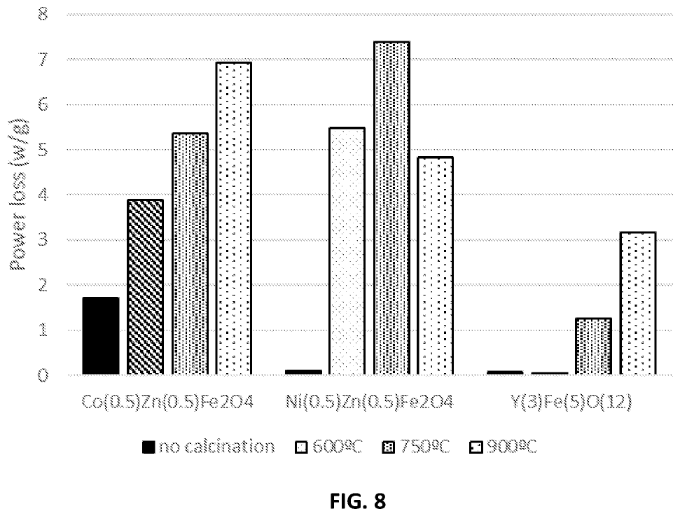

FIG. 8 shows the induction power loss due to magnetic hysteresis heating for Co_{0.5}Zn_{0.5}Fe₂O₄, Ni_{0.5}Zn_{0.5}Fe₂O₄, and Y₃Fe₅O₁₂, where the power loss=Cₚ×(ΔT/Δt). The factor (ΔT/Δt) was measured as described in Example 1 and Cₚ is the specific heat of the metal oxide material. The general trend is for power loss to increase as the calcination temperature increases from 600° C. to 750° C. to 900° C. This means that the induction heating properties of Co_{0.5}Zn_{0.5}Fe₂O₄, Ni_{0.5}Zn_{0.5}Fe₂O₄, and Y₃Fe₅O₂ are activated by the calcination process. This is not generally the case for other materials in Table 1. Among the metal oxides listed in Table 1, only the three shown in FIG. 8 show an increase in activity for magnetic induction heating after calcination at 600° C., 750° C., and 900° C. These materials are of special interest since they show induction heating properties after treatment at temperatures consistent with standard aging conditions for typical emission catalysts.

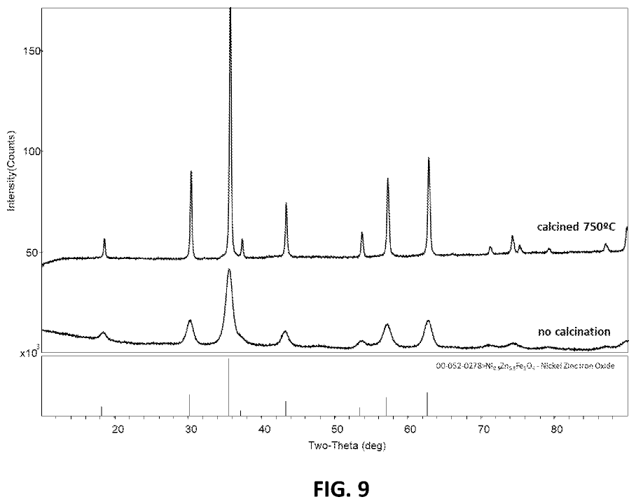

FIG. 9 shows an X-ray diffraction pattern for Ni_{0.5}Zn_{0.5}Fe₂O₄ powder in the as-is state and after calcination at 750° C. for 5 hr in air. The calcined powder shows more narrow diffraction peaks indicative of greater long-range crystalline order in the material. The only structural phase observed in the plot is the spinel-type nickel-zinc ferrite oxide. The diffraction peaks are significantly broadened for the fresh material relative to the aged powder, indicating that the crystallite size has appreciably increased after aging. There are no additional diffraction peaks appearing that suggest decomposition to other oxide products.

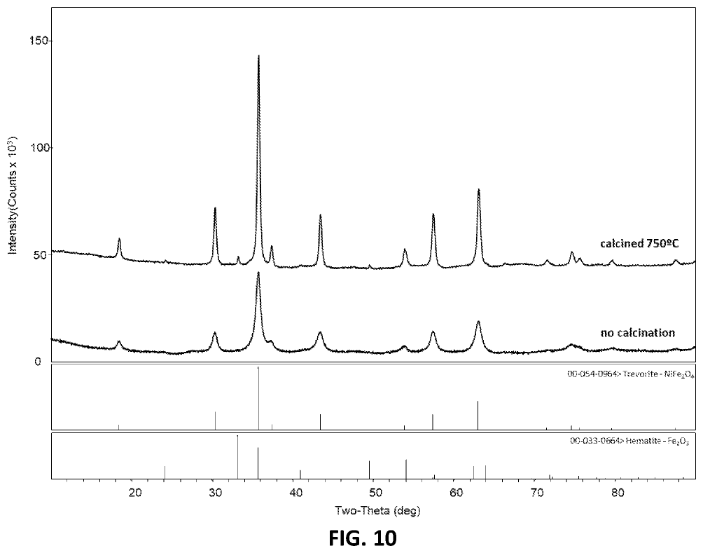

The X-ray diffraction data for the pure nickel ferrite NiFe₂O₄ is shown in FIG. 10. The pattern shows nearly the same diffraction peaks as Ni_{0.5}Zn_{0.5}Fe₂O₄, confirming these two compounds are isostructural with each other. However, the diffractogram of NiFe₂O₄ in the fresh state shows more narrow peaks relative to Ni_{0.5}Zn_{0.5}Fe₂O₄, indicating a larger crystallite size for the as-is NiFe₂O₄. The diffractogram for NiFe₂O₄ shows only a small decrease in peak width after aging at 750° C., but the aged powder does appear to contain a small amount of hematite, probably derived from the decomposition reaction:

Ni₂Fe₂O₄→Fe₂O₃+NiO.

Since Ni_{0.5}Zn_{0.5}Fe₂O₄ showed no evidence for formation of Fe₂O₃ after aging, it is suggested (although not intending to be limited by theory) that that the presence of the Zn²⁺ ion along with Ni²⁺ in the A^{II} site stabilized the spinel structure against decomposition relative to NiZnFe₂O₃.

In addition, the BET surface area of Ni_{0.5}Zn_{0.5}Fe₂O₄ decreased from 106 m²/g in the as-is state to 11 m²/g after calcination at 750° C. for 5 hr. Assuming a collection of nominally spherical particles, then the relationship between grain radius r and BET surface area ABET is:

r=3/ρA_{BET}

where ρ is the density of the material. Since the BET decreased by about 10-fold after calcination at 750° C., the average crystallite radius has also increased by about 10-fold. Therefore, the increase in induction heating activity is believed to be associated with an increase in the crystallite size. Although not intending to be limited by theory, these data point towards the hindered migration of magnetic domain boundaries as a primary origin for the kinetic barrier to magnetic reorientation in these materials leading to heating by magnetic hysteresis loss. Formation of these boundaries is probably favored by larger crystallites that encompass more than one magnetic domain.

### Example 3: Composition of Ferrite Materials

XPS data on Ni_{0.5}Zn_{0.5}Fe₂O₄ and NiFe₂O₄ are shown in Table 2. If we assume the general spinel-type stoichiometry AₓFe₃₋ₓO₄, then Table 2 shows that the nickel-containing ferrite materials are slightly iron-poor (x>1) relative to the nominal spinel composition. It must be recognized that photoelectrons generated by the XPS measurement escape from a depth of only about 20 Å, and so it is possible that this non-stoichiometric composition is a surface phenomenon. In addition, the nickel-containing ferrite samples are oxide-poor, indicating formation of vacancies or defects in the spinel oxide lattice. The decrease in oxide stoichiometry is more pronounced after high-temperature treatment, suggesting that the number of crystal defects is increased. Such crystal defects are known to stabilize or “pin” magnetic domain boundaries within the crystallite. The number of defect sites and the strength of this domain pinning will influence the kinetics for reorienting the magnetization in the material. Although not intending to be limited by theory, it is suggested that an increase in the number of defect sites leads to a slower magnetic reorientation, an increase in the area under the magnetic hysteresis curve, and greater thermal loss during magnetic cycling. For comparison, metal and oxide stoichiometry of manganese-containing ferrite materials is shown in Table 3. These materials show oxide stoichiometry very near to 4, consistent with the nominal spinel composition. This indicates that these materials have fewer defects in the oxide lattice. Although not intending to be limited by theory, it is suggested that the low magnetic heating rate for the manganese-containing ferrite materials is partially due to the small number of lattice defects.

TABLE 2
Stoichiometric composition of nickel-containing ferrite
nanomaterials in fresh and aged (750° C.) states
measured by XPS compared with the nominal composition.

| Nominal composition | Fe | Ni | Zn | oxide |
|---|---|---|---|---|
| Ni_{0.5}Zn_{0.5}Fe₂O₄ (fresh) | 1.9 | 0.5 | 0.6 | 3.8 |
| Ni_{0.5}Zn_{0.5}Fe₂O₄ (750° C.) | 1.4 | 0.4 | 0.6 | 3.2 |
| NiFe₂O₄ (fresh) | 1.4 | 1.6 | 0.0 | 3.7 |
| NiFe₂O₄ (750° C.) | 1.7 | 1.0 | 0.0 | 3.4 |

TABLE 3
Composition of manganese-containing ferrite nanomaterials
in fresh and aged (600° C.) states measured
by XPS compared with the nominal composition.

| Nominal composition | Fe | Mn | Zn | oxide |
|---|---|---|---|---|
| MnFe₂O₄ (fresh | 1.4 | 1.2 | 0.0 | 4.1 |
| MnFe₂O₄ (600° C.) | 1.1 | 1.4 | 0.0 | 4.0 |
| Mn_{0.5}Zn_{0.5}Fe₂O₄ (fresh) | 1.3 | 0.5 | 1.1 | 3.9 |
| Mn_{0.5}Zn_{0.5}Fe₂O₄ (600° C.) | 1.6 | 0.6 | 0.6 | 3.9 |

### Example 4: Maximum Operating Temperature for Different Ferrite Materials

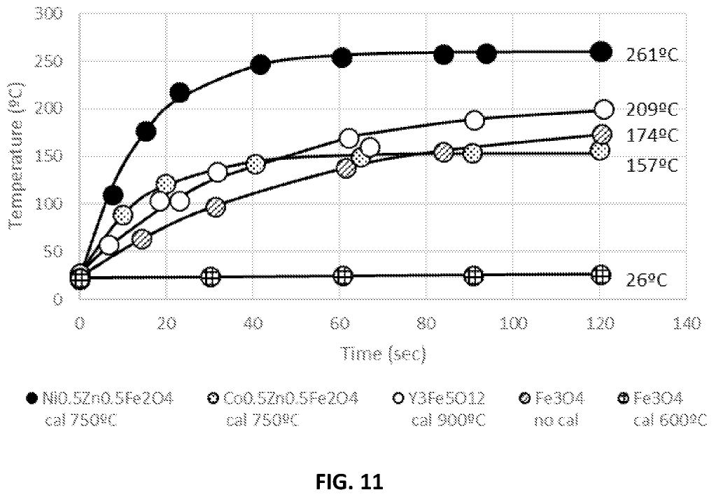

For any magnetic material, there will be a maximum working temperature for induction heating limited by the Curie temperature of the material. Above this temperature, the internal magnetic moments in the material are uncorrelated and the material will behave as a simple paramagnet. FIG. 11 shows the profile of temperature vs time for five powders over the course of 120 sec during exposure to a 60 kHz alternating magnetic field in the induction coil apparatus described in Example 1. The Ni_{0.5}Zn_{0.5}Fe₂O₄ powder goes from 25° C. to 250° C. in the first 40 sec of the test, and then the temperature stabilizes at 261° C. and does not rise further. Co_{0.5}Zn_{0.5}Fe₂O₄ is also initially heated rapidly, but it reaches a terminal temperature of only 157° C. due to the lower Curie temperature for this material. The Y₃Fe₅O₁₂ oxide material reaches a maximum working temperature of near 209° C., but it is not heated as rapidly as Ni_{0.5}Zn_{0.5}Fe₂O₄ or Co_{0.5}Zn_{0.5}Fe₂O₄. In the fresh state, the magnetic iron oxide powder shows a heating profile similar with Y₃Fe₅O₁₂. But after mild calcination at 600° C., the heating efficiency is lost due to conversion to inactive hematite.

### Example 5: Effect of Magnetic Dilution

For a ferromagnetic or ferrimagnetic material placed inside a uniform coil, the power loss to the material in the core is given by the expression:

P_{core}=K₁B^{a}fⁿV

or on a per unit volume basis,

P_{core}/V=K₁B^{a}fⁿ

where f is the operating AC frequency. B is the internal magnetization of the core material, and K₁ is an empirical parameter related to the material. The power loss is related to the temperature change in the core by:

dT/dt=P_{core}/Vcₚρ

where Cₚ is the specific heat of the core and ρ is the density. Combining these two equations gives:

dT/dt=K₁B^{a}fⁿ/Cₚρ

which relates the rate of temperature change in the material to key material and process parameters. We begin with a fixed AC frequency f, and we assume the heat capacity and density of the magnetic material are known or can be reliably estimated. In addition, the material factor K₁ is fixed for a given magnetic material. Under these restrictions, the rate of change in the temperature of the coil depends mainly on the magnetization B, which in turn depends on the amount of magnetic material incorporated in the core. Therefore, the relationship between the rate of temperature increase and the amount of magnetic material in the core is important data informing the design of inductively-heated catalyst washcoats.

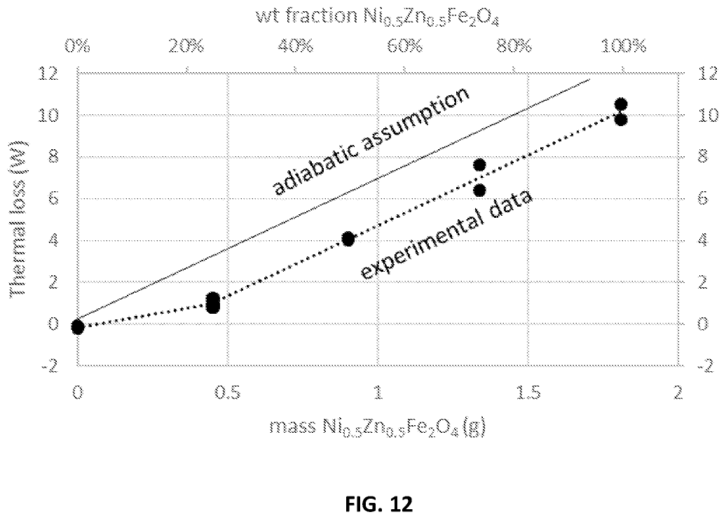

The effect of magnetic dilution on inductive thermal loss to the sample was evaluated by preparing a series of powder mixtures containing Ni_{0.5}Zn_{0.5}Fe₂O₄ (calcined 750° C.) and Al₂O in various ratios as shown in Table 4. The resulting powder mixtures were ground together in a mortar and pestle and fully homogenized. The inductive thermal loss for each powder was measured at 60 kHz AC frequency using the device described in Example 1. The values are corrected for the change in heat capacity as a function of the powder composition. The results in FIG. 12 show that the thermal loss is nominally linear between 25 wt % and 100 wt % Ni_{0.5}Zn_{0.5}Fe₂O₄. There is an offset between the experimental power loss (estimated from the change in temperature of the sample) and the expected power loss assuming equivalent heating of all the particles. This offset arises via loss of some heat to the surroundings, a consequence of the fact that the experimental setup is not strictly adiabatic. The slope of the linear region gives an estimate for the thermal power loss per unit mass of Ni_{0.5}Zn_{0.5}Fe₂O₄ to be about 6.7 W/g under the applied process conditions.

TABLE 4
Description of powder samples generated
for magnetic dilution study

| Composition Ni_{0.5}Zn_{0.5}Fe₂O₄ | | specific heat |
|---|---|---|
| content (wt %) | mass (g) | (J/g · K)^{a} |
| 0% | 1.78 | 0.98 |
| 25% | 1.79 | 0.92 |
| 50% | 1.81 | 0.87 |
| 75% | 1.79 | 0.81 |
| 100% | 1.81 | 0.75 |

^{a}Weighted average of specific heat for Ni_{0.5}Zn_{0.5}Fe₂O₄ (0.75 J/g · K) and γ-Al₂O₃ (0.98 J/g · K).

### Example 6: Compatibility of Magnetic Ferrite Compounds with SCR Catalyst Technology

A model catalyst powder formulation for selective catalytic reduction was prepared as follows. 106 g of copper-exchanged chabazite zeolite were suspended in deionized water. Then 5.1 g of zirconium oxide was added and the suspension was homogenized for 30 min. The resulting suspension was split into two equal portions. 51 g of Ni_{0.5}Zn_{0.5}Fe₂O₄ (calcined 750° C.) was added to one portion, heretofore called SCR-IHC. 51 g of aluminum oxide powder was added to the other portion, heretofore called SCR-only. The two resulting suspensions were dried under stirring, taking care not to use magnetic stirring equipment for this step. The two powders were calcined at 450° C. for 1 hr in air. The calcined powder pellet was crushed and sieved to a fraction between 250-500 μm diameter. A portion of each sieved powder was then aged at 800° C. for 5 hr in 10% steam/air. The remainder was retained as fresh powder material.

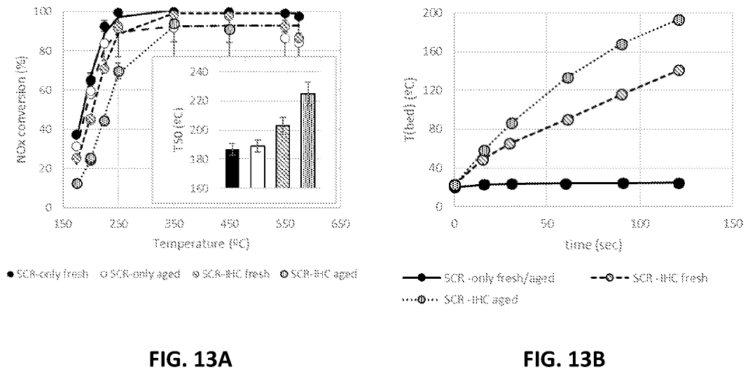

120 mg of each fresh or aged powder was diluted to 1.0 cm³ with corundum and packed into a cylindrical reactor bed. The beds were evaluated for selective catalytic reduction under steady state feed conditions: NO=500 ppm, NH₃=500 ppm, H₂O=5.0%, O₂=10%, balance N₂, SV=80,000/hr. For each powder, a degreening evaluation was run between 200-575° C. and then data was collected from the second evaluation. The NOₓ conversion profiles are shown in FIG. 13A. The data showed that the SCR-IHC powder exhibits NOₓ conversion with lightoff below 250° C. even after hydrothermal aging at 800° C. The inset shows Tso values for each sample. Powders containing Ni_{0.5}Zn_{0.5}Fe₂O₄ do show higher Tso than the corresponding powder diluted with aluminum oxide, but are still within the range exhibited by commercial SCR catalyst technology. 1.2 g of each powder was packed into 1 mL glass sampler vial and evaluated for induction heating as described in Example 1. FIG. 13B shows the results of the induction heating test. The fresh and aged powders that were diluted with aluminum oxide show no increase in temperature when exposed to the alternating magnetic field in the coil. The powders that were diluted with Ni_{0.5}Zn_{0.5}Fe₂O₄ show an increase in temperature during exposure the alternating magnetic field. The aged powder shows faster heating response than the fresh powder in this case. This may be due to removal of adsorbed water, which is especially pronounced in zeolite-containing powders and leads to some irreproducibility in the evaluation of the heating effect. A conclusion from Example 6 is that the catalyst powder SCR-IHC demonstrates both NOₓ conversion activity by SCR and induction heating activity.

### Example 7: Compatibility of Magnetic Ferrite Compounds with AMOx Catalyst Technology

A model catalyst powder formulation for selective ammonia oxidation was prepared as follows. 20 g of aluminum oxide powder was impregnated with platinum at a loading of 0.58 wt %. The impregnated powder was suspended in DI water along with 89 g copper-exchanged chabazite zeolite. The suspension was milled to homogenize, and then split into two equal portions. 51 g of Ni_{0.5}Zn_{0.5}Fe₂O₄ (calcined 750° C.) was added to one portion, heretofore call AMOx-IHC. 51 g of aluminum oxide powder was added to the other portion, heretofore called AMOx-only. The two resulting suspensions were dried under stirring, taking care not to use magnetic stirring equipment for this step. The two powders were calcined at 450° C. for 1 hr in air. The calcined powder pellet was crushed and sieved to a fraction between 250-500 μm diameter. A portion of each sieved powder was then aged at 800° C. for 5 hr in 10% steam/air. The remainder was retained as fresh powder material.

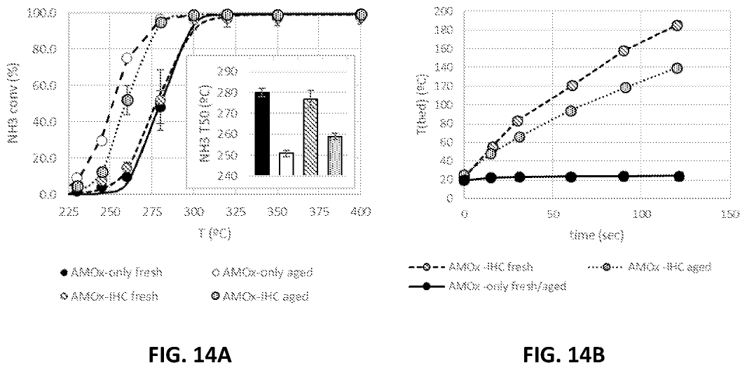

33 mg of each fresh or aged powder was diluted to 1.0 cm with corundum and packed into a cylindrical reactor bed. The beds were evaluated for selective ammonia oxidation under steady state feed conditions: NH₃=200 ppm, H₂O=6.5%, O₂=10%, CO₂=7.0%, balance N₂, SV=100,000/hr. The NH₃ conversion profiles are shown in FIG. 14A. The data show a typical behavior in which NH₃ oxidation activity improves somewhat after aging, and this is observed in the AMOx-only and AMOx-IHC powders. The effect of Ni_{0.5}Zn_{0.5}Fe₂O₄ on NH₃ lightoff temperature is small as shown by the Tso values for NH₃ conversion in the inset.

1.2 g of each powder was packed into 1 mL glass sampler vial and evaluated for induction heating as described in Example 1. FIG. 14B shows the results of the induction heating test. The fresh and aged powders that were diluted with aluminum oxide show no increase in temperature when exposed to the alternating magnetic field in the coil. The powders that were diluted with Ni_{0.5}Zn_{0.5}Fe₂O₄ show an increase in temperature during exposure the alternating magnetic field. The aged powder shows slower heating response than the fresh powder, but this is ascribed to differences in the moisture content of the samples, which is especially pronounced in zeolite-containing powders and leads to some irreproducibility in the evaluation of the heating effect. The key conclusion from Example 7 is that the catalyst powder AMOx-IHC demonstrates both NH₃ oxidation activity and induction heating activity.

### Example 8: Compatibility of Magnetic Ferrite Compounds with TWC Catalyst Technology

A model catalyst powder formulation for three-way catalyst activity was prepared as follows. 32 g of ceria/zirconia mixed oxide powder was impregnated with palladium to a loading of 1.7 wt % and dried at 120° C. under mild stirring. 64 g of aluminum oxide powder was impregnated with rhodium to a loading of 0.16% and dried at 120° C. under mild stirring. The impregnated powders were suspended in deionized water and milled to homogenize. 2.7 g barium acetate and 3.4 g strontium acetate hemihydrate were added to the suspension, and the pH was adjusted to 4.0 with nitric acid while stirring. The resulting suspension was split into two equal portions. 51 g of Ni_{0.5}Zn_{0.5}Fe₂O₄ (calcined 750° C.) was added to one portion, heretofore call TWC-IHC. 51 g of aluminum oxide powder was added to the other portion, heretofore called TWC-only. The two resulting suspensions were dried under stirring, taking care not to use magnetic stirring equipment for this step. The two powders were calcined at 450° C. for 1 hr in air. The calcined powder pellet was crushed and sieved to a fraction between 250-500 μm diameter. A portion of each sieved powder was then aged at 800° C. for 5 hr in 10% steam/air. The remainder was retained as fresh powder material.

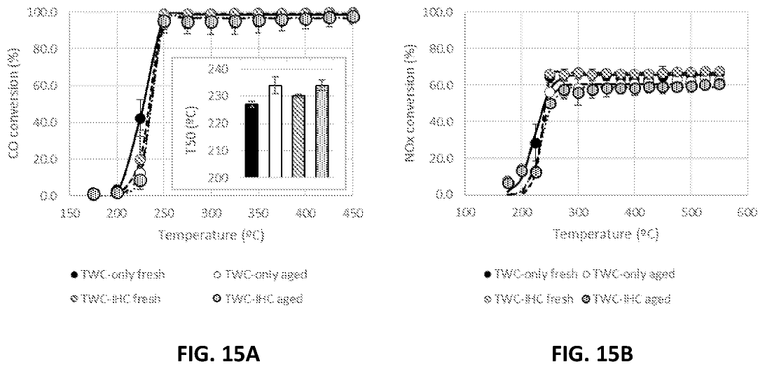

340 mg of each fresh or aged powder was diluted to 1.0 cm³ with corundum and packed into a cylindrical reactor bed. The beds were evaluated for conversion of CO and NO under oscillating lean/rich feed conditions. Lean condition (1 sec): CO=0.7%. H₂=0.22%, propylene/propane=2250 ppm C₁, NO=1500 ppm, O₂=1.8%, CO₂=14%, H₂O=10%, balance=N₂. Rich condition (1 sec): CO=2.33%, H₂=0.77%, propylene/propane=2250 ppm C₁, NO=1500 ppm. O₂=0.7%, CO₂=14%, H₂O=10%, balance=N₂. SV=70,000/hr. The average CO conversion profiles (taken over 15 lean-rich cycles) at each temperature are shown in FIG. 15A, and the average NO conversion (taken over 15 lean-rich cycles) is shown in FIG. 15B. The charts show that inclusion of Ni_{0.5}Zn_{0.5}Fe₂O₄ has only a small effect on CO and NO conversion in the fresh state and no significant effect after aging at 800° C.

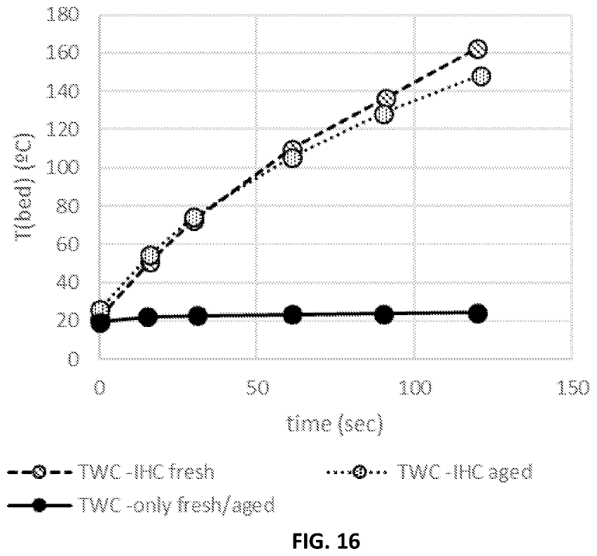

1.2 g of each powder was packed into 1 mL glass sampler vial and evaluated for induction heating as described in Example 1. FIG. 16 shows the results of the induction heating test. The fresh and aged powders that were diluted with aluminum oxide show no increase in temperature when exposed to the alternating magnetic field in the coil. The TWC catalyst powders that were diluted with Ni_{0.5}Zn_{0.5}Fe₂O₄ show an increase in temperature during exposure the alternating magnetic field. The fresh and aged powders show equivalent heating response. The key conclusion from Example 8 is that the catalyst powder TWC-IHC demonstrates both CO and NOₓ conversion oxidation activity and induction heating activity.

### Example 9. Compatibility of Magnetic Ferrite Compounds with DOC Catalyst Technology

A model catalyst powder formulation for DOC catalyst activity was prepared as follows. 100 g aluminum oxide powder was impregnated with platinum and palladium to a loading of 1.1 wt % Pt and 0.36 wt % Pd. The impregnated powder was combined with DI water to give a suspension having 30 wt % solids content. The pH of the suspension was adjusted to 4.5 using nitric acid, and then milled for 10 min to homogenize. The resulting suspension was split into two equal portions. 51 g of Ni_{0.5}Zn_{0.5}Fe₂O₄ (calcined 750° C.) was added to one portion, heretofore call DOC-IHC. 51 g of aluminum oxide powder was added to the other portion, heretofore called DOC-only. The two resulting suspensions were dried under stirring, taking care not to use magnetic stirring equipment for this step. The two powders were calcined at 450° C. for 1 hr in air. The calcined powder pellet was crushed and sieved to a fraction between 250 μm and 500 μm diameter. A portion of each sieved powder was then aged at 800° C. for 5 hr in 10% steam/air. The remainder was retained as fresh powder material.

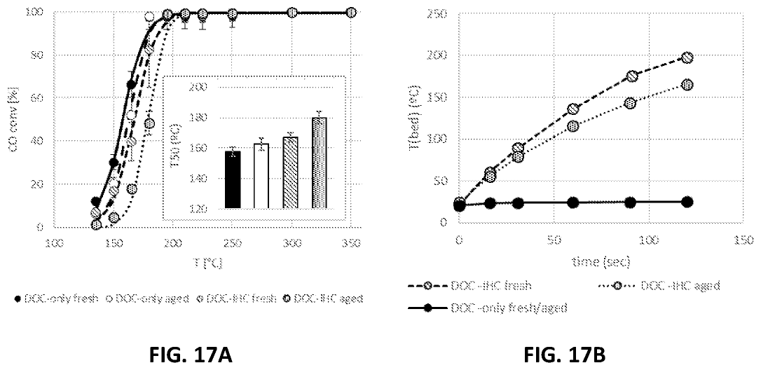

100 mg of each fresh or aged powder was diluted to 1.0 cm with corundum and packed into a cylindrical reactor bed. The beds were evaluated for conversion of CO under steady-state feed conditions: NO=100 ppm, CO=800 ppm, propylene=100 ppmC₁, decane=200 ppmC₁, toluene=100 ppmC₁, O₂=10%, CO₂=10%, H₂O=10%, balance=N₂. SV=45,000/hr. The CO conversion profiles at each temperature are shown in FIG. 17A. The DOC powder formulation containing Ni_{0.5}Zn_{0.5}Fe₂O₄ gives T₅₀≤180° C. after aging at 800° C.

1.2 g of each fresh and aged powder was packed into 1 mL glass sampler vials and evaluated for induction heating as described in Example 1. FIG. 17B shows the results of the induction heating test. The fresh and aged powders that were diluted with aluminum oxide show no increase in temperature when exposed to the alternating magnetic field in the coil. The DOC catalyst powders that were diluted with Ni_{0.5}Zn_{0.5}Fe₂O₄ show an increase in temperature during exposure the alternating magnetic field. The aged powder shows only a slight decrease in heating response relative to the fresh powder. A conclusion from Example 9 is that the catalyst powder DOC-IHC demonstrates CO oxidation activity and induction heating activity.

### Example 10: Compatibility of Magnetic Ferrite Compounds with LNT Catalyst Technology

A model catalyst powder formulation for LNT catalyst activity was prepared as follows. 58 g cerium oxide was impregnated with rhodium to a level of 0.084 wt % Rh. The impregnated powder was dried at 120° C. and then calcined at 450° C. for 1 hr. Separately. 25 g of aluminum oxide was impregnated with platinum and palladium to a level of 3.8 wt % Pt and 0.45 wt % Pd. The impregnated powder was then combined with deionized water to make a suspension having 30 wt % solids content. 20 g barium acetate, 25 g magnesium acetate, and 0.80 g zirconium oxide were added to the suspension with stirring to homogenize. The suspension was milled until the particle size D₉₀=10 micron. The calcined powder was added to the suspension along with 1.8 g dispersible alumina. The resulting suspension was split into two equal portions. 51 g of Ni_{0.5}Zn_{0.5}Fe₂O₄ (calcined 750° C.) was added to one portion, heretofore call LNT-IHC. 51 g of aluminum oxide powder was added to the other portion, heretofore called LNT-only. The two resulting suspensions were dried under stirring, taking care not to use magnetic stirring equipment for this step. The two powders were calcined at 450° C. for 1 hr in air. The calcined powder pellet was crushed and sieved to a fraction between 250 μm and 500 μm diameter. A portion of each sieved powder was then aged at 800° C. for 5 hr in 10% steam/air. The remainder was retained as fresh powder material.

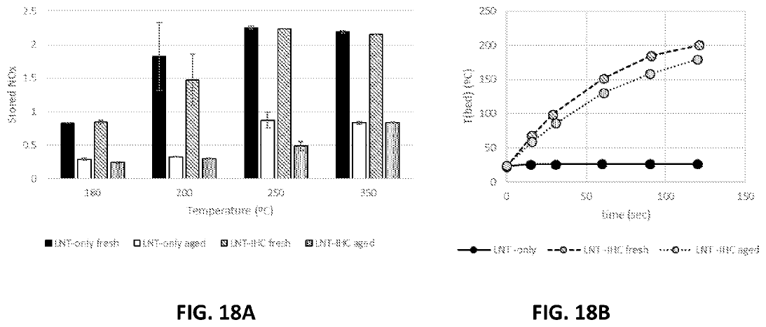

200 mg of each fresh or aged powder was diluted to 1.0 cm³ with corundum and packed into a cylindrical reactor bed. The beds were evaluated for trapping of NOₓ under oscillating lean/rich feed conditions. Lean condition (600 sec): CO=1500 ppm, NO=180 ppm, O₂=10%, CO₂=6%, H₂O=6%, balance=N₂. Rich condition (30 sec): CO/H₂=3/1, NO=180 ppm, O₂=0.9%, CO₂=6.0%, H₂O=6.0%, balance=N₂, lambda=0.95 (set by adjustment of CO/H₂ content). SV=70,000/hr, The NOₓ emission profiles were recorded as a function of time over the course of three sequential lean-rich cycles, and the amount of NOx stored in the lean phase was calculated by integration at each time point during the last cycle. The chart in FIG. 18A shows the amount of NOₓ trapped at the point where NOₓ emission=54 ppm (e.g. 30% of the inlet NOₓ level). Aging at 800° C. has a strong effect on the amount of NOₓ trapped, but inclusion of Ni_{0.5}Zn_{0.5}Fe₂O₄ has only a small effect on NOₓ trapping except at 250° C.

1.2 g of each fresh and aged LNT powder was packed into 1 mL glass sampler vials and evaluated for induction heating as described in Example 1. FIG. 18B shows the results of the induction heating test. The fresh and aged powders that were diluted with aluminum oxide show no increase in temperature when exposed to the alternating magnetic field in the coil. The LNT catalyst powders that were diluted with Ni_{0.5}Zn_{0.5}Fe₂O₄ show an increase in temperature during exposure the alternating magnetic field. The aged powder shows only a slight decrease in heating response relative to the fresh powder. A conclusion from Example 10 is that the catalyst powder LNT-IHC demonstrates NOₓ trapping activity under conditions relevant for LNT operation and activity for induction heating.

### Example 11: Evaluation of a Coated Catalyst Monolith Containing Magnetic Ferrite Compound

A formulation for selective catalytic reduction was prepared and coated onto a ceramic monolith as follows. 190 g of copper exchanged chabazite zeolite and 10 g zirconium oxide were suspended in deionized water to give a suspension having 37 wt % solids content. The pH was adjusted to 5.5. The suspension was wet-milled to give a particle size D₉₀=9.4 micron. A ceramic monolith (cordierite, channel density 400/in³, wall thickness of 4 mil, 12×12 channel cross section, 3 inch length) was immersed in the slurry fully and extracted. The excess slurry was removed by an air jet, and the wet piece dried at 150° C. in a heated air jet. The dried piece was calcined at 550° C., resulting in a part that had 2.0 g/in³ washcoat loading. Five replicate pieces were produced. These pieces were identified as SCR-only parts. One part from this set was aged in a tube furnace at 800° C. for 16 hr in a flowing stream (3 L/min flow) consisting of 10% H₂O/air. The remainder of the parts were retained as fresh parts.

Separately, 173 g Ni_{0.5}Zn_{0.5}Fe₂O₄ powder (calcined 750° C.), 20 g dispersible aluminum oxide, and 10 g zirconium oxide was suspended in deionized water. The pH was adjusted to 6.3, and the suspension wet-milled to a particle size D₉₀ 11.4 micron. This slurry was combined with the slurry above in a 1:2 ratio (solids basis), and homogenized by high-shear mixer. A ceramic monolith (cordierite, channel density 400/in³, wall thickness of 4 mil, 12×12 channel cross section, 3 inch length) was immersed in the new slurry fully and extracted. The excess slurry was removed by an air jet, and the wet piece dried at 150° C. in a heated air jet. The dried piece was calcined at 550° C., resulting in a part that had 3.0 g/in³ dry gain. Five replicate pieces were produced. These pieces were identified as SCR-IHC parts. One part from this set was aged in a tube furnace at 800° C. for 16 hr in a flowing stream (3 L/min flow) consisting of 10% H₂O/air. The remainder of the parts were retained as fresh parts.

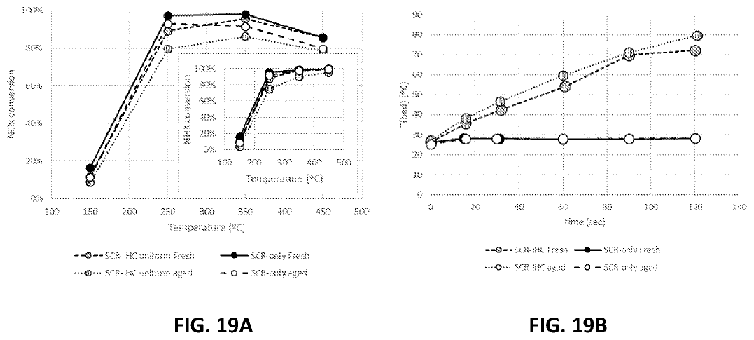

The fresh and aged parts were evaluated for selective catalytic reduction activity in a model gas reactor under steady state feed conditions: NO=500 ppm, NH; =500 ppm, H₂O=5.0%, O₂=10%, balance N₂, SV=80,000/hr. The NOₓ conversion profiles are shown in FIG. 19A. The data show that the SCR-IHC part exhibits NOₓ conversion with lightoff below 250° C. even after hydrothermal aging at 800° C. The inset shows NH conversion profiles, which show NH lightoff concurrent with NOₓ lightoff.

The same ceramic monoliths were mounted in the induction coil apparatus described in Example 1. The wire thermocouple was inserted into a channel in the middle of the ceramic part. The alternating current was applied to the coil and the temperature reading for the thermocouple was recorded as a function of time. FIG. 19B shows the results of the induction heating test. The fresh or aged monolith samples coated with SCR catalyst without Ni_{0.5}Zn_{0.5}Fe₂O₄ show no increase in temperature when exposed to the alternating magnetic field in the coil. The monoliths coated with the washcoat containing Ni_{0.5}Zn_{0.5}Fe₂O₄ show an increase in temperature during exposure to the alternating magnetic field. The fresh and aged SCR-IHC parts give equivalent heating activity. These data indicate that coated monoliths can be constructed that demonstrate both SCR catalytic activity and induction heating activity.

### Example 12: Distribution of Heat in Coated Monoliths with Magnetic Ferrite Compound

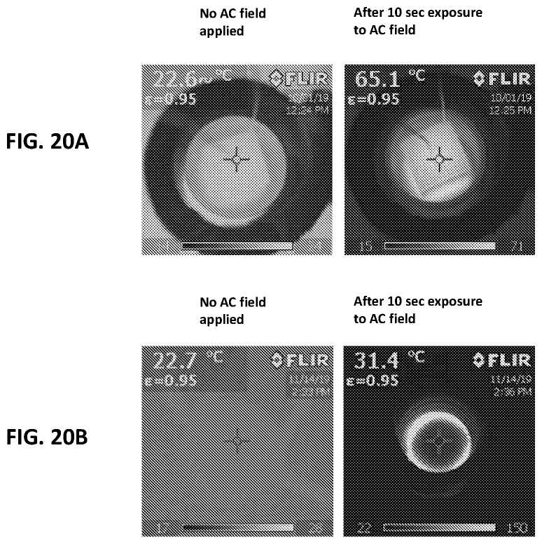

The distribution of heat generated in a coated monolith during magnetic heating was evaluated using IR thermometry images as shown in FIG. 20A. The images in FIG. 20A show the SCR-IHC washcoat formulation prepared in example 11, coated on a ceramic substrate which is then mounted in the induction coil. The left image shows the temperature profile before the AC current is applied to the induction coil and the right image shows the temperature profile 10 sec after application of the AC current begins. The temperature reading was recorded by the IR camera at the location of the crosshairs in the image. The images show that the SCR-IHC part is heated uniformly across the cross-section of the part with only minimal gradient in the temperature profile. This behavior is contrasted with FIG. 20B, which was generated by mounting a metal substrate in the induction coil. The image on the right shows the IR image 10 sec after application of the AC current to the induction coil. The image shows a very inhomogeneous distribution in temperature. The outer rim of the metal part is heated very strongly and the middle of the part is not heated at all by the induction process. This effect may be a consequence of the fact that the conductive metal part is heated by the generation of alternating eddy currents in the part, which generate heat by electrical resistance. The electrical “skin-effect” may cause the alternating current to propagate through the conductive body only along the outer surface, and so only the outer surface of the conductive body can be heated by induction. As more time passes, the center of the part becomes heated via conduction from the outer rim, but the heat is applied only to the outer rim. These images show that the modified washcoat containing Ni_{0.5}Zn_{0.5}Fe₂O₄ has an appreciable advantage in uniformity of heating relative alternative induction heating strategies based on the generation of eddy current in a conductive part.

While the disclosure herein has been described by means of specific embodiments and applications thereof, numerous modifications and variations could be made thereto by those skilled in the art without departing from the scope of the disclosure set forth in the claims. Furthermore, various aspects of the disclosure may be used in other applications than those for which they were specifically described herein.

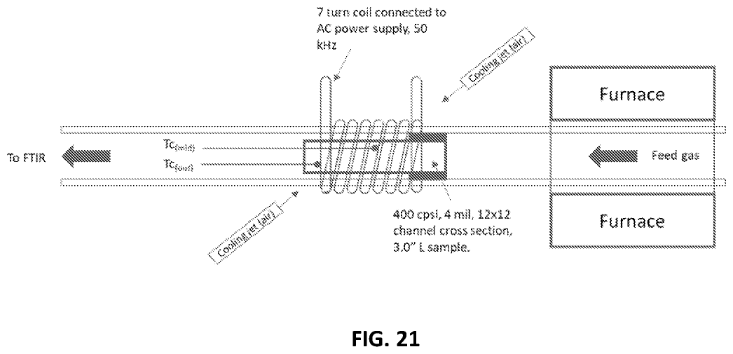

Example 13: A quartz tube was placed in a tube furnace with about 18 inches of glass tubing extending beyond the furnace outlet. The monolith catalyst sample was mounted in the tube about 8″ downstream of the furnace outlet. Two thermocouples were inserted into the channels of the monolith to measure the mid-bed and outlet temperature of the sample. A heavy-gauge insulated flexible braided wire was wrapped around the outside of the glass tube where the sample was mounted, so that the sample was situated inside the coil. This wire was connected to an AC power supply providing about 50-60 kZ frequency AC current to the coil. Two air jets were directed onto the coil to cool it and prevent resistive heating of the system. The gas feed stream (500 ppm NO, 500 ppm NH₃, 5% CO₂, 5% H₂O, 10% O₂, balance=N₂, Flow=10 U/min) was pre-heated to the target baseline temperature by passing the stream through the furnace and then into the sample. The effluent from the sample was passed to an FTIR where the concentration of NO and NH was measured. FIG. 21 shows a schematic diagram of the apparatus. At each furnace setpoint, outlet NO and NH₃ concentrations were measured by the FTIR and temperature readings were recorded. The temperature and concentration readings were repeated with no power to the coil and with power to the coil turned on.

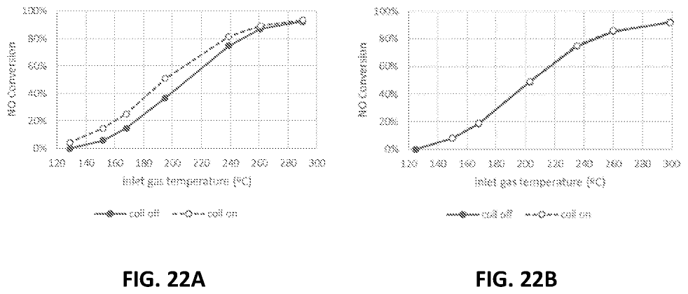

The aged SCR-only and SCR-IHC coated monolith samples described in Example 11 were selected for further evaluation using the apparatus described above. FIG. 22A shows that the SCR-only formulation gave T₅₀=200° C., and there was no difference between the measurement with the coil power turned on or off. In contrast, FIG. 22B shows that the NO conversion profile for the SCR-IHC formulation shifted towards lower temperature when the AC power to the coil was switched on relative to the baseline profile with power switched off. The Tso value shifted 15° C. lower when the AC power was turned on. The response to AC power was nearly instantaneous: Conversion immediately increased when power was turned on and dropped to the baseline level as soon as power was switched off. The increase in conversion is due to an increase in catalyst internal temperature relative to inlet gas temperature when the coil power is turned on.

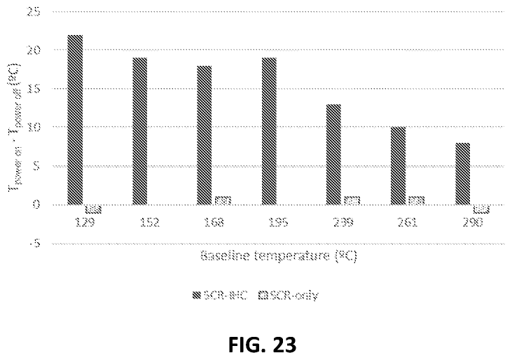

FIG. 23 shows the difference in temperature measured by the mid-bed thermocouple with the AC power to the coil switched on or off. The SCR-only formulation showed no increase in temperature in response to the application of the AC field. The SCR-IHC formulation showed a higher mid-bed temperature when AC power was applied to the coil. The magnitude of the temperature increase became smaller as the baseline temperature became higher and approached the Curie temperature of the magnetic material. These data demonstrate that catalytic conversion under operating conditions can be increased by increasing the bed temperature of the catalyst using magnetic hysteresis. The catalytic activity and magnetic hysteresis heating are maintained after aging at hydrothermal conditions relevant for emission catalysts.

1. A catalyst composition comprising:
a catalytic material; and
at least one magnetic component;
wherein the magnetic component comprises at least one magnetic ferrite compound.

2. The catalyst composition of claim 1, wherein the magnetic ferrite compound comprises iron, and one or more of zinc, cobalt, nickel, yttrium, manganese, copper, barium, strontium, scandium, and lanthanum.

3. (canceled)

4. The catalyst composition of claim 2, wherein the magnetic ferrite compound comprises iron, nickel, and zinc.

5. The catalyst composition of claim 4, wherein the nickel/zinc molar ratio ranges from about 1/99 to about 99/1.

6. (canceled)

7. (canceled)

8. The catalyst composition of claim 1, wherein the magnetic ferrite compound comprises Ni_{0.5}Zn_{0.5}Fe₂O₄, Co_{0.5}Zn_{0.5}Fe₂O₄, or Y₃Fe₅O₁₂.

9. The catalyst composition of claim 2, wherein the magnetic ferrite compound comprises iron, cobalt, and zinc.

10. The catalyst composition of claim 9, wherein the cobalt/zinc molar ratio ranges from about 1/99 to about 99/1.

11. (canceled)

12. (canceled)

13. (canceled)

14. The catalyst composition of claim 2, wherein the magnetic ferrite compound comprises iron and yttrium.

15. (canceled)

16. (canceled)

17. (canceled)

18. The catalyst composition of claim 1, wherein the magnetic ferrite compound has a Brunauer-Emmett-Teller (BET) surface area of less than about 100 m²/g.

19. The catalyst composition of claim 1, wherein the magnetic ferrite compound is the form of nanoparticles.

20. (canceled)

21. The catalyst composition of claim 1, wherein the catalytic material comprises a catalytic material for one or more of oxidation of carbon monoxide, oxidation of hydrocarbons, oxidation of NOx, oxidation of ammonia, selective catalytic reduction of NOx, and NOx storage/reduction.

22. The catalyst composition of claim 1, wherein the catalytic material comprises one or more catalytic metals impregnated or ion-exchanged in a porous support, wherein the one or more catalytic metals are selected from base metals, platinum group metals, oxides of base metals or platinum group metals, and combinations thereof.

23. The catalyst composition of claim 22, wherein the porous support is a refractory metal oxide or a molecular sieve.

24. (canceled)

25. A catalytic article for treatment of exhaust gas emissions from an internal combustion engine, comprising:
a flow-through substrate or wall-flow filter, having the catalyst composition of claim 1 deposited thereon, wherein the article is adapted for use as a diesel oxidation catalyst (DOC), catalyzed soot filter (CSF), lean NOx trap (LNT), selective catalytic reduction (SCR) catalyst, ammonia oxidation (AMOx) catalyst, or three-way catalyst (TWC).

26. (canceled)

27. An emission control system comprising:
the catalytic article of claim 25; and
a conductor for receiving current and generating an alternating magnetic field in response thereto, wherein the conductor is positioned such that the generated alternating magnetic field is applied to at least a portion of the catalyst composition.

28. The emission control system of claim 27, wherein the conductor is a coil of conductive wire surrounding at least part of the catalytic article.

29. The emission control system of claim 27, further comprising an electric power source electrically connected to the conductor for supplying alternating current thereto, or a temperature sensor positioned to measure the temperature of gases entering the catalytic article and a controller in communication with the temperature sensor, wherein the controller is adapted to control the current received by the conductor such that the controller can energize the conductor with current when heating of the catalytic article is desired.

30. (canceled)

31. A method of treating exhaust gas emissions from an internal combustion engine, comprising passing the exhaust gas emissions through the emission control system of claim 27.

32. (canceled)

33. A fixed bed catalyst system, comprising:
a catalyst bed having a catalyst composition comprising a catalytic material; and at least one magnetic component: wherein the magnetic component comprises at least one magnetic ferrite compound; and
a conductor for receiving current and generating an alternating magnetic field in response thereto, wherein the conductor is positioned such that the generated alternating magnetic field is applied to at least a portion of the catalyst composition.

34. A method for producing a catalytic material, comprising:
heating a ferrite compound at a temperature of about 600° C. or greater for about an hour or more to give a magnetic ferrite compound; and
combining the magnetic ferrite compound with a catalytic material.

35. (canceled)
